(19) United States
(12) Patent Application Publication
(10) Pub. No.: US 2019/0303931 A1
(43) Pub. Date: Oct. 3, 2019

(54) METHOD OF, SYSTEM FOR, DATA PROCESSING DEVICE, AND INTEGRATED CIRCUIT DEVICE FOR IMPLEMENTING A DISTRIBUTED, LEDGER-BASED PROCESSING AND RECORDING OF AN ELECTRONIC FINANCIAL TRANSACTION

(71) Applicant: Renato Valencia, Muntinlupa City, Metro Manila (PH)

(72) Inventor: Renato Valencia, Muntinlupa City, Metro Manila (PH)

(21) Appl. No.: 15/509,200

(22) PCT Filed: Dec. 21, 2016
(86) PCT No.: PCT/IB2016/057862

§ 371 Date: Mar. 7, 2017

(51) Int. Cl. G06Q 20/40

(52) U.S. Cl. CPC G06Q 20/401; G06Q 20/24

(57) ABSTRACT

Consistent with one or more aspects of the present invention, there is disclosed a distributed, ledger-based processing and recording of an electronic financial transaction implemented using hardware and/or software application programs and utilizing a device-resident ledger system. Processing and/or recording of the financial transaction can be performed by a transaction processing system which may be any one of a cluster of participating nodes (which may be operated by banks), a third party payment processing system associated with the cluster of participating nodes, and a distributed ledger system associated with the cluster of participating nodes. The may be private ledgers, public ledgers, or hybrids of private and public ledgers. The device-resident ledger system which serves as a digital passbook may be a mirror of an issuer-resident ledger system, may cooperate with the distributed ledger system or similar technology, and may be incorporated into an integrated circuit device (e.g., a chip in a card and NFC-enabled SIM card), which, by itself or incorporated in or linked to other devices like a mobile phone, a POS reader, tablet, computer or similar devices, as well as accessories like a watch, bracelet, eyeglass, ring, pen, or similar devices, can enable and/or implement a financial transaction (e.g., payment and trading).

### CROSS-REFERENCE TO RELATED APPLICATIONS

NONE

### FEDERALLY SPONSORED RESEARCH

NOT APPLICABLE

### SEQUENCE LISTING OR PROGRAM

NOT APPLICABLE

### TECHNICAL FIELD

The present invention generally relates to electronic transaction processing but more particularly to a distributed, ledger-based processing and recording of an electronic financial transaction.

### BACKGROUND ART

Electronic financial transaction systems such as the conventional card (e.g., debit card, credit card) payment systems and the emerging mobile payment systems have dramatically grown worldwide over decades, principally driven by payment technology networks such as Visa, AmEX, and MasterCard. More recently, such transaction systems are driven by alternative technology companies such as PayPal, Amazon Payments, and Stripe. Thankfully, these systems, together with banks and other institutions, have enabled trade and commerce to grow and flourish in the past decades.

The card payment process, in one instance, is clearly defined and followed: first is the authorization process, in which the card issuer authorizes the card or mobile phone subscriber to purchase goods and/or services from a network-accredited merchant; and then followed by clearing and settlement which enable the subscriber to pay in full the merchant who gives a merchant discount to the payment community (issuer, acquirer, third party processor, etc.) for goods provided and/or services rendered.

Over time, payment devices have evolved from plastic card with magnetic stripe to plastic card with integrated circuit device or chip, to RFID (Radio Frequency Identification System), to SE (Secure Element) such as SIM card, SD (Smart Digital) card, etc., and then to HCE (Host-based Card Emulation) in an electronic device like a mobile phone. Even accessories or wearables such as watches, bracelets, rings, pens, etc. are beginning to contain circuitries which are designed for conducting transactions such as payment transactions.

While payment devices are trending from passive plastic cards or wearables to the more versatile, more powerful electronic devices such as mobile phones and computers which are equipped with data communication capabilities, the general payment infrastructure has remained card-centric and centralized. Hence, a new device like the mobile phone or the communication-equipped computer, with all its versatile and powerful features, acts more like a traditional payment card, unable to exploit its powerful features and full potential.

Further, while technological advances have enabled said payment infrastructure to speed up transactions, protect the transaction or payment system's integrity and earn the trust of the subscribers and the community, it is now beginning to show its age, flaws and vulnerabilities which may include, but not limited to: (i) it has become so huge and rigid, held together by so many rules to protect the stability, security and integrity of the system; (ii) it is network-dependent in that if the network is down, the merchant has to resort to other means to enable the transaction to push through and be cleared and settled; (iii) it is back-end dependent in that the authorization, clearing and settlement processes go through the backend infrastructure a number of times to ensure completion of the transaction; and (iv) over time, more processes, rules, and players (such as tokenization, payment gateways, etc.) have been added to the existing payment system thus preventing friction costs, direct or indirect, from significantly going down.

### SUMMARY OF THE INVENTION

Consistent with one or more aspects of the present invention, there is disclosed a distributed, ledger-based processing and recording of an electronic financial transaction using hardware and/or software application programs and utilizing device-resident ledger system. Processing and/or recording of the financial transaction can be performed by a transaction processing system which may be any one of (i) a cluster of participating nodes which may be operated by banks, (ii) a third party payment processing system associated with the cluster of participating nodes, and (iii) a distributed ledger system associated with the cluster of participating nodes. The distributed ledgers associated with the distributed ledger system may be private ledgers, public ledgers, or hybrids of private and public ledgers.

The device-resident ledger system which serves as a digital passbook may be a mirror of an issuer-resident ledger system, may cooperate with the distributed ledger system or similar technology, and may be incorporated into an integrated circuit device (e.g., a chip in a card, NFC-enabled SIM card, SIM card) which, by itself or incorporated in or linked to other devices like a mobile phone, a POS reader, tablet, computer or similar devices, as well as accessories like a watch, bracelet, eyeglass, ring, pen, or similar devices, can enable and/or implement a financial transaction (e.g., payment, reimbursement, lending) through automatic debit/credit system or by interacting with other ledgers representing the accounts of the acquirer, merchant, issuer, and the clearing and settlement bank.

The provision of the ledger-based processing and recording of the financial transaction introduces transparency into the existing payment systems by simplifying and decentralizing the processes and working in conjunction with any one or more, or any one or more suitable combinations, of the following features: (i) the transaction, which may be a payment transaction, may be authorized by the subscriber at the point of sale, wherein the subscriber, knowing his available balance for payment in his digital passbook or ledger, does not need to request authorization from his issuer at the backend using the technology network, and wherein the device-resident ledger system which acts as a digital passbook may be an extension of the subscriber's account (e.g., credit, debit, pre-paid, current, savings and other accounts) with the issuer, wherein the device-resident ledger system may be digitized or emulated and incorporated in the mobile phone's NFC (near field communication)-enabled SIM (subscriber's identification module) card, wherein the device-resident ledger system, and as well as the account balances associated with it, may be synchronized and updated on-demand or on schedule with applicable communications network permitting, wherein the availability of the device-resident ledger system and its associated balance to the subscriber enables the subscriber to authorize a merchant to debit his transaction account with the issuer to pay the merchant in real-time; (ii) only one payment or transaction cycle is required from initial payment instruction by the subscriber with his digital passbook/ledger, to clearing and settlement of accounts using automatic debit and credit, instead of the tedious and repetitive authorization, clearing and settlement processes using the infrastructure of the technology network; (iii) through automatic debit and credit from one transaction device to the other (e.g., from NFC-enabled SIM card to the POS reader), and one party to the other (e.g., from the subscriber to the acquirer), the merchant and the payment community may be paid quickly and efficiently; (iv) since the payment cycle is reduced and simplified, payment of merchants and the community may be done efficiently in clusters, thus decentralizing the payment infrastructure, reducing players, processes, and ultimately, friction costs; (v) through the distributed ledger system or similar technology, transactions are transparent and fraud is minimized, if not eliminated; (vi) two redundant networks connect to the backend: first is through the POS reader, the second, through the mobile phone whereby continuity of financial transactions even if one network is down is ensured; (vii) the device-resident ledger system may be activated, updated and loaded/credited over-the-air (OTA), thus eliminating the need for digital cash vending machines and stations; (viii) open or proprietary systems may be used and arranged to be applicable to closed or open payment loop; (ix) transactions may be proximity (“tap and pay”), online, short-range, medium-range, or long-range; (x) financial transactions may be envisioned to be multi-currencies and cross borders; and (xi) communications characterized by SIM card to SIM card, SIM card to mobile phone, “peer to peer” transactions, or the like, may be arranged or enabled to be conducted in accordance with one or more aspects of the invention as presently disclosed.

For a better understanding of the invention and to show how the same may be performed, preferred embodiments and/or implementations thereof will now be described, by way of non-limiting examples only, with reference to the accompanying drawings.

### BRIEF DESCRIPTION OF THE SEVERAL VIEWS OF THE DRAWINGS

FIG. 1 is a flow diagram illustrating a computer-implemented method of implementing a distributed, ledger-based processing and recording of an electronic financial transaction in accordance with one aspect of the invention, showing three transaction processing options: (a) cluster of participating nodes; (b) third party payment processing system, or (c) distributed ledger/network system.

FIG. 1A is a flow diagram illustrating a further computer-implemented method of implementing a distributed, ledger-based processing and recording of an electronic financial transaction in accordance with one or more embodiments of the invention.

FIGS. 2, 2A, 2C, 2E and 2G are block diagrams illustrating different implementations of a transaction device which can be used for implementing a distributed, ledger-based processing and recording of an electronic financial transaction consistent with one or more aspects of the invention.

FIG. 3 is a block diagram illustrating example components of a transaction processing system which can be used for implementing a distributed, ledger-based processing and recording of an electronic financial transaction consistent with one or more aspects of the invention.

FIG. 4 is a block diagram illustrating example components of a distributed ledger system which can be used for implementing a distributed, ledger-based processing and recording of an electronic financial transaction consistent with one or more aspects of the invention.

FIG. 5 is a flow diagram illustrating an example validation process suitable for use in one or more aspects of the invention.

FIG. 6 is a flow diagram illustrating an example risk management process suitable for use in one or more aspects of the invention.

FIG. 7 is a block diagram illustrating exemplary information associated with the validation process of the invention.

FIGS. 8 and 9 are high level block diagrams collectively illustrating a process for authenticating a transaction suitable for use in one or more aspects of the invention.

FIG. 10 is a flow diagram illustrating an example closed loop payment process suitable for use in one or more aspects of the invention.

FIG. 11 is a flow diagram illustrating an example detailed closed loop payment process suitable for use in one or more aspects of the invention.

FIG. 12 is a high level block diagram illustrating an exemplary data communication network suitable for use in the one or more aspects of the invention.

FIG. 13 is a block diagram illustrating the high level components of an electronic circuit device in accordance with one or more aspects of the invention.

FIG. 14 is a block diagram illustrating an electronic device with an NFC (near-field communication)-enabled integrated circuit device of FIG. 13.

FIG. 15 is a block diagram illustrating an electronic device with an NFC-enabled integrated circuit device of FIG. 13 having a plurality of application software programs.

FIG. 16 is a flow diagram illustrating a process for operating application programs containing processing procedures executable for performing an NFC-based outgoing transaction using a digital passbook/ledger.

FIG. 17 is a flow diagram illustrating a process for operating an application program containing processing procedures executable for performing an NFC-based outgoing transaction using an electronic checkbook account.

FIG. 18 is a flow diagram illustrating a process for issuing the integrated circuit device of FIG. 13.

FIG. 19 is a flow diagram illustrating a process for linking the integrated circuit device of FIG. 13 to a subscriber's issuer account.

FIG. 20A is a flow diagram illustrating a process for loading an electronic wallet account associated with the integrated circuit device of FIG. 13 via OTA (over-the-air).

FIG. 20C is a flow diagram illustrating a process for loading an electronic wallet associated with the integrated circuit device of FIG. 13 via OTC (over-the-counter).

FIG. 20E is a flow diagram illustrating a process for loading a digital passbook associated with the integrated circuit device of FIG. 13 account via phone-to-phone (peer-to-peer).

FIG. 21A is a flow diagram illustrating a process for executing a payment transaction with an electronic wallet account associated with the integrated circuit device of FIG. 13 via phone to POS (point of sale) reader.

FIG. 21C is a flow diagram illustrating a process for executing a payment transaction with a digital passbook associated with the integrated circuit device of FIG. 13 via phone-to-phone.

### DETAILED DESCRIPTION OF THE PREFERRED EMBODIMENTS

For the purposes of promoting and understanding of the principles of the present invention, reference will now be made to the implementations and/or embodiments illustrated in the drawings and specific language will be used to describe the same. Nevertheless, it is to be understood and appreciated by a person skilled or having ordinary skills in the art to which the present invention belongs that no limitation of the scope of the present invention is thereby intended. Any alterations and/or further modifications in the ensuing detailed description of the preferred implementations and/or embodiments, and as well as any further applications of any one or all associated principles, of the present invention are contemplated as would normally occur to the artisan.

As may be used herein, the term “system,” as, for example, in the case of transaction processing “system” or distributed ledger “system,” may refer to a collection of one or more hardware, software, combinations of hardware and software, or firmware components, and may be used to refer to an electronic computing device or devices, or one or more subsystems thereof, within which one or more sets of computer-executable instructions, which are tangibly embodied in one or more machine-readable media, may be executed by the hardware components in order to perform arithmetic operations, logical operations, timing operations, and specialized functions applicable to specific task objects and consequently produce control outputs and/or control signals associated with the present invention in accordance with one or more implementations and/or embodiments thereof.

As may be used herein, the term “entities” may refer to any human and/or legal figures involved in the use or utilization of one or more portions, aspects, implementations, or embodiments of the present invention. In particular, entities can include an individual person, an organization, an association, an institution, a service provider, and the like that implement one or more portions of one or more aspects of the present invention as described and/or contemplated herein. By way of examples and not by way of limitation, these entities can be a mobile phone user, a subscriber, an internet service provider, a transaction processing service provider such as a payment processing service provider, a payment settlement service provider, a data communications service provider, a service provider of distributed network of computers or peer-to-peer computer network without central authority, intermediaries, interpreters, or layers, an issuer, an issuer's processor, an acquirer, an acquirer's processor, and a settlement bank.

As may be used herein, the term “application,” as, for example, in the case of transaction application, emulated transaction application, or transaction applet, may refer to an executable computer software program or software application program that enables services and content associated with implementation of the herein disclosed distributed, ledger-based processing and recording of an electronic financial transaction to be provided to transaction devices. The application may be a mobile application or any other application that is executable via any one or more of a transaction device, a server, a network of computers, a transaction processing system, and/or a distributed ledger system. The program or programs which may constitute the application may be a self-contained software or is a component of or contained by another program or programs, any of which may be implemented by one or more hardware, software, firmware and/or cloud resources comprising one or more infrastructure stacks and one or more infrastructure components such as application servers, file servers, DNS (domain name system) servers, directory servers, web servers, network servers, group servers, database servers, batch servers, and the like.

As may be used herein, the terms “transaction device” may refer to device consisting of hardware and/or software application programs, incorporated in an integrated circuit device like a chip in a card, NFC-enabled SIM card, SIM card, SD card and similar devices, which by itself or incorporated in or linked to other devices like a mobile phone, a POS reader, tablet, computer or similar devices, as well as accessories like a watch, bracelet, eyeglass, ring, pen, or similar devices. It is to be understood and appreciated that the transaction device of the present invention may have various equivalents which are well known in the art of computing.

As may be used herein, the terms “distributed ledger system” may refer to combinations of hardware and software systems which provide distributed data structure in a decentralized computing framework and which support various computational functions which may include distributing computational tasks such as validating transaction ownership and managing transaction risk from one or more computer systems to one or more other computer systems in a distributed network. These computer systems in the distributed ledger system may also be characterized by a peer-to-peer network of computers or computer systems. Public, private, or a hybrid of public and private ledgers included in the distributed ledger system may include blocks containing data which are represented by transactions and/or transaction messages, linking data which are arranged to link a current block to a previous block in a chain of the blocks provided with transactions and/or transaction messages, data recording and tracking system for ensuring validity of the transactions performed through the chain of the blocks with proof of work data. Cryptography, such as by way of implementing digital signatures, may be used to protect the computing environment which characterizes the distributed ledger system and to provide the distributed ledger system with audit logs that are verifiable, sealable and/or redactable. By way of encrypting the transaction messages using such digital signatures which may include the step of convolving the transaction messages with known keys, the chronological order of the blocks in the chain can be identifiable and traceable without complexities in operation, and integrity of the data associated with the transaction and/or transaction messages can be arranged such that they are independently verifiable by each node in the distributed network on which the distributed ledger system resides.

As may be used herein, the term “node” may be a stand-alone device, a distributed device, a remotely operable device, or a cluster of distributed and decentralized devices. The node may be made operable to perform computations and as well as acquisitions of data from and/or transmission of data to another computing devices such as server devices, transaction devices, and other hardware components. The node may be or may include a micro-controller, a single central processing unit (CPU), a plurality of processing units, a digital signal processor (DSP), a single computing system, or a cluster of computing systems. The node may include a communication module that communicates with wired or wireless data and/or radio communication networks. The node may be operated by each participating entity in the distributed network. The participating entity operating the node may be a custodial or financial processing entity such as a bank, a trust company, a thrift institution, a credit union, a credit card company, and the like. Cluster of financial transactions may be processed by each node or each cluster of the nodes. Clustering the nodes may be based on geographical locations associated with the entities which operate them.

As may be used herein, the term “ledger” may refer to a computer-generated and/or computer-based principal book or “digital passbook” for recording monetary values which are associated with transactions conducted using transaction accounts. The digital passbook may be a computer-based file which is provided with debits and credits in separate columns. The debits and credits columns may be automatically generated and/or updated upon successfully conducting an electronic financial transaction, and may include a beginning balance and an ending balance for each transaction account which may be a deposit account, a trust account, a line of credit account, a loan product account, a payment card account, a health savings account, a retirement savings account, or the like. Automatic debit and credit among the various accounts and the ledgers associated with the accounts of the participants (e.g., subscribers, issuers, acquirers, merchants, clearing and settlement banks) until all the transactions are fully cleared and settled.

As may be used herein, the terms “data communication network” may refer to any number of communication systems which may include a plurality of the transaction devices, a plurality of the server devices or systems, and a plurality of the nodes preferably adapted for wireless communication with one another. For example, the data communication network may refer to any number of data communication systems including one or more of the following communication networks and/or frameworks: a public or private data network, a hybrid public and private data network, a wired or wireless data network, an IP (Internet Protocol) framework, a WLAN (wireless local area network), a WWAN (wireless wide area network), a GAN (global area network), a MAN (metropolitan area network), an LTE (Long Term Evolution) network of any generation, a mobile WiMax (worldwide interoperability for microwave access) network, an enterprise intranet, the like, and/or combinations thereof.

As may be used herein, and alternatively, the terms “data communication network” or “communication network” may refer to any number of communication systems which may include a plurality of the transaction devices and a plurality of the nodes preferably adapted for wireless communication with one another, and may also refer to various radio access technologies, bidirectional wireless communication frameworks and/or short-range wireless communication frameworks, pathways, and protocols which are well known in the art. These technologies may include or may be based on Bluetooth™, Bluetooth™ low energy, IEEE 802.15, any IEEE protocol selected from any one of the 802.11x protocols, other applicable IEEE protocols not related to 802.11x, Zigbee™, Z-Wave™, WLAN (wireless local area network), Wi-Fi (Wireless Fidelity), NFC (Near Field Communication), GPRS (General Packet Radio Service), GSM (Global System for Mobile TeleCommunications), HSDPA (High-Speed Downlink Packet Access), HSUPA (High-Speed Uplink Packet Access), WiMax (worldwide interoperability for microwave access) network, CDMA (code division multiple access), RF (radio-frequency) protocol, Infrared protocol, GHOST (General Hardware-Oriented Software Transfer) protocol, DLNA (Digital Living Network Alliance) protocol, the like, and/or any suitable combination thereof.

As may further be used herein, the terms “connected to,” “connecting,” “communicating,” “in communication with,” “in operative communication with,” “interconnected,” or “interconnecting” may include direct connection/communication, indirect connection/communication and/or inferred connection/communication between devices/apparatuses/computers/. The direct connection/communication may be provided through one or more hardware, software, firmware, electronic and/or electrical links between devices/apparatuses. The indirect connection/communication may be provided through an intervening member such as a component, an element, a circuit, a module, a device, a node device, and an apparatus between or among devices/apparatuses. The inferred connection/communication, as may be used herein, may be characterized by one device/apparatus being connected to or in operative communication with another device/apparatus by inference, and may include direct and indirect connections/communications.

As may be used herein, the terms “financial transaction” may refer to an electronic transaction which may be characterized by payment, reimbursement, payroll, remittance, financing, lending, loan, mortgage, deposit, investment, trading, insurance, crowd-funding, banking, to name but a few, in an efficient, secure and seamless manner. Online payment related transactions, checkout related transactions, credit-related transactions, debit-related transactions, charge-related transactions, prepaid-related transactions, and the like, may also characterize the terms “financial transaction” which can or may be any operation involving transfer of funds to or from at least one electronic transaction account using any transaction device with hardware and/or software application programs which are operative communications with one another.

All the ensuing disclosures and illustrations of the preferred implementations of the present invention, along with one or more components, features or elements thereof, are merely representative for the purpose of sufficiently describing the manner by which the present invention may be carried out into practice in various ways other than the ones outlined in the ensuing description.

It is to be understood and appreciated by a person skilled in the art or having ordinary skills in the art, however, that the exemplary implementations used to describe how to make and use the present invention may be embodied in many alternative forms and should not be construed as limiting the scope of the appended claims in any manner, absent express recitation of those features in the appended claims. All the exemplary drawings, diagrams and illustrations accompanying the ensuing description should also not be construed as limiting the scope of the appended claims in any manner.

Unless the context clearly and explicitly indicates otherwise, it is to be understood that like reference numerals refer to like elements throughout the ensuing description of the figures and/or drawings, that the linking term “and/or” includes any and all combinations of one or more of the associated listed items, that the singular terms “a”, “an” and “the” are intended to also include the plural forms, and that some varying terms or terminologies of the same meaning and objective may be interchangeably used throughout the ensuing disclosure.

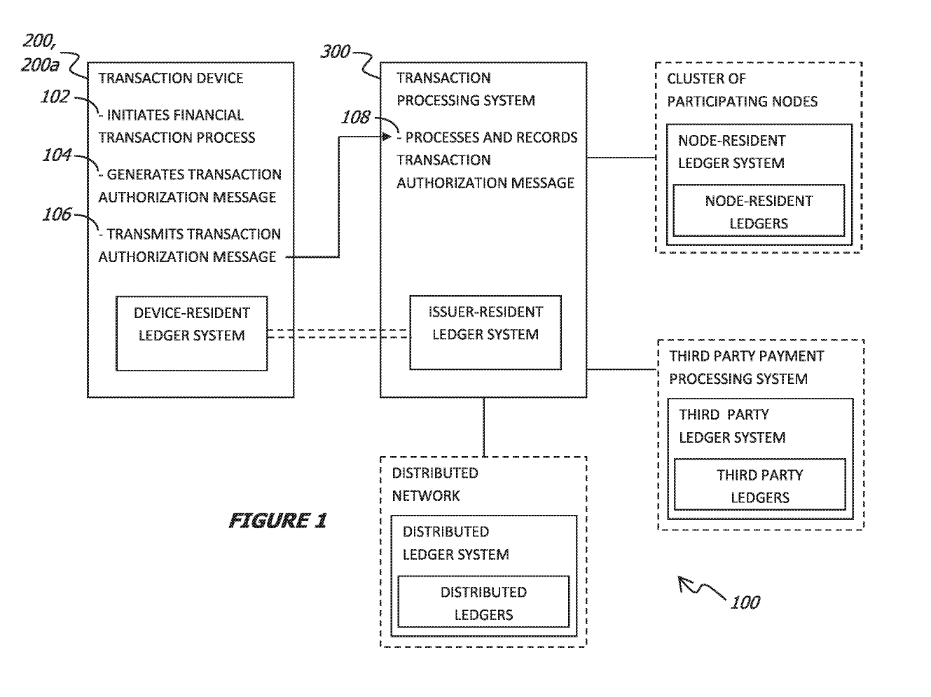

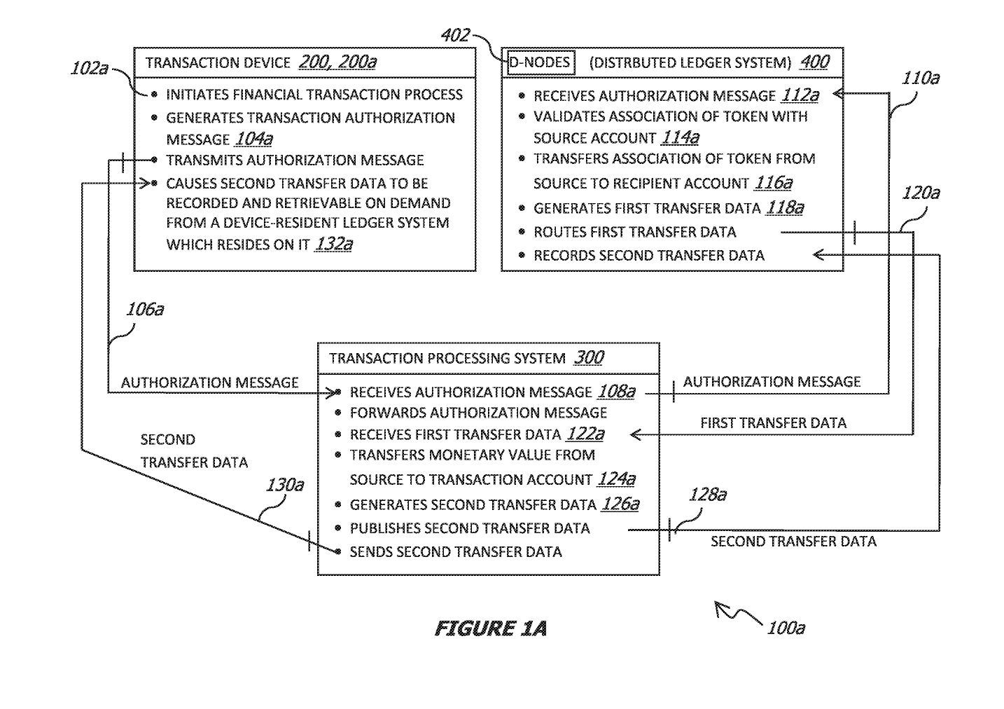

One aspect of the present invention is directed to a computer-implemented method of implementing a distributed, ledger-based processing and recording of an electronic financial transaction. The method, as illustrated in the flow diagram of FIG. 1, is generally designated by reference numeral 100. The method 100 comprises: (i) initiating, by a transaction device 200, 200a, a financial transaction process associated with the financial transaction and in response to a first input signal received at the transaction device 200, 200a (step 102); (ii) generating, by the transaction device 200, 200a, a transaction authorization message in response to a second input signal received at the transaction device 200, 200a, wherein the transaction authorization message includes identifiers of at least a source transaction account and a recipient transaction account which is distinct from the source transaction account, and debit and credit related data associated with the source and recipient transaction accounts (step 104); (iii) transmitting, by the transaction device 200, 200a, the transaction authorization message to a transaction processing system 300 with which the source transaction account is associated (step 106); and (iv) processing and recording, by the transaction processing system 300, the transaction authorization message (step 108).

In the method 100, the transaction processing system 300 is any one of a cluster of participating nodes associated with the source transaction account, a third party payment processing system associated with the cluster of participating nodes, and a distributed ledger system associated with the cluster of participating nodes. The debit and credit related data are automatically posted from the transaction authorization message to a device-resident ledger associated with a device-resident ledger system residing on the transaction device 200, 200a and, consequently, to any one of one or more node-resident ledgers associated with a node-resident ledger system residing on the cluster of participating nodes, one or more third party ledgers associated with a third party ledger system residing on the third party payment processing system, and one or more distributed ledgers associated with the distributed ledger system residing on a distributed network. The device-resident ledger system is a mirror of an issuer-resident ledger system maintained at the transaction processing system 300 and corresponding to the node-resident ledger system. The device-resident ledger system may be tracked by the distributed ledger system 400. The node-resident ledger system may be tracked by the distributed ledger system 400. The third party ledger system may tracked by the distributed ledger system 400.

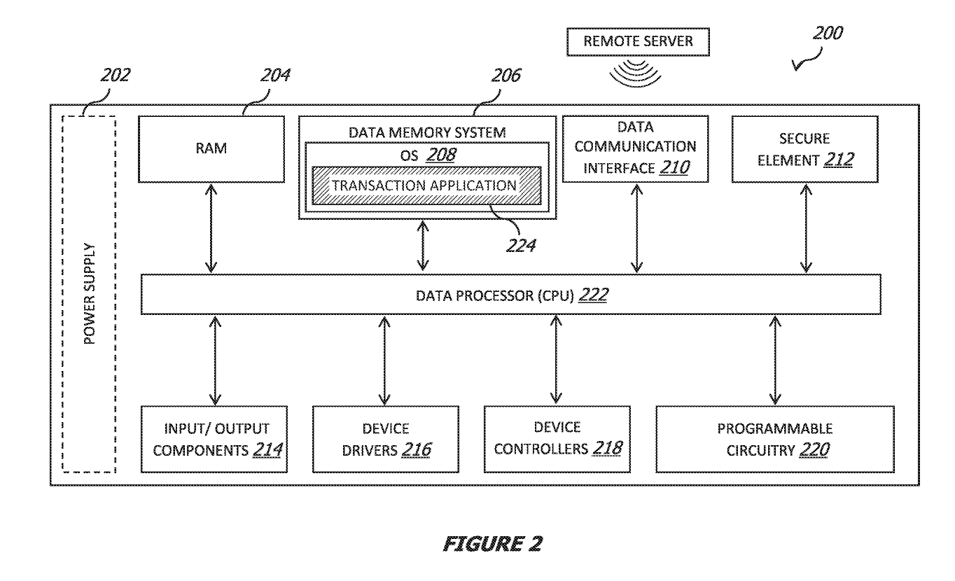

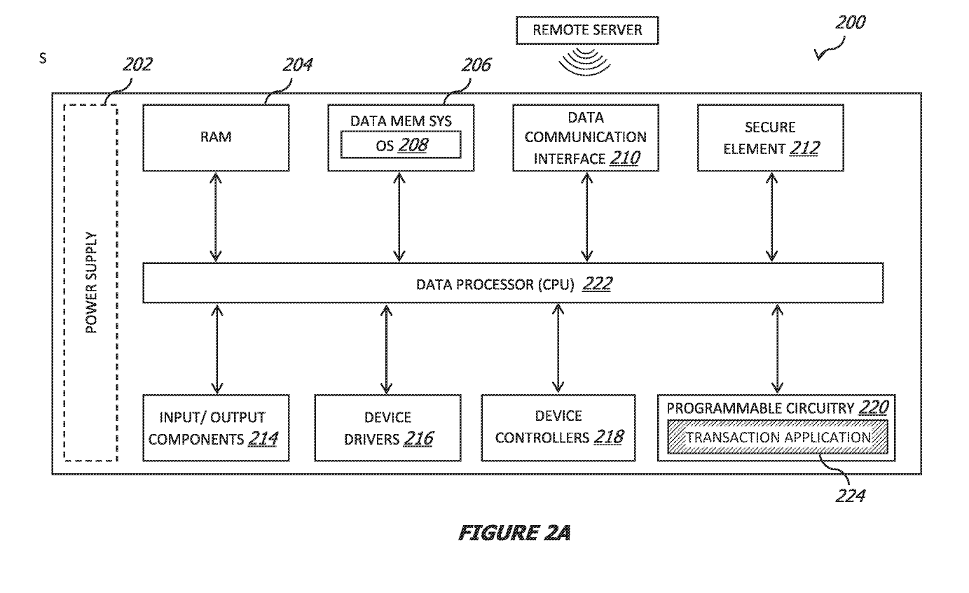

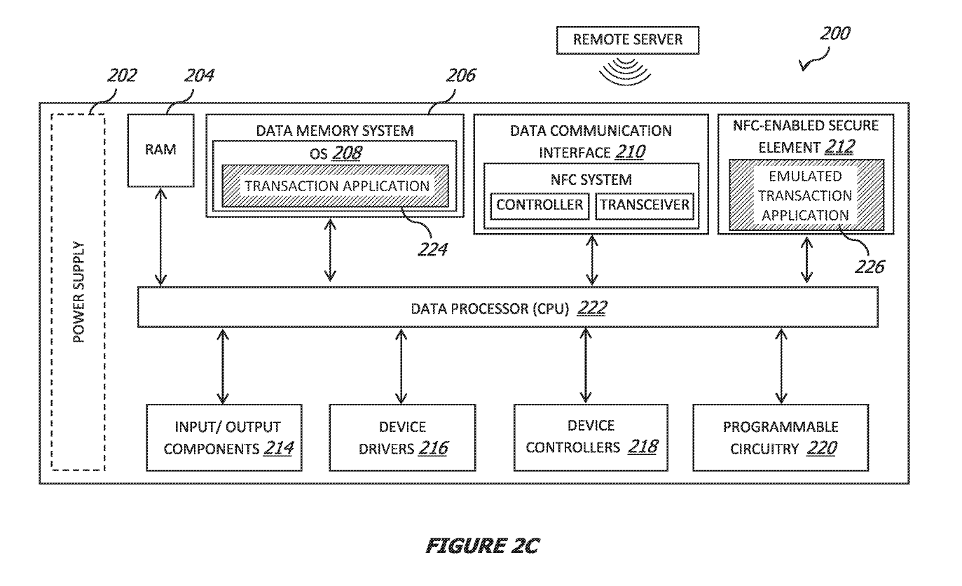

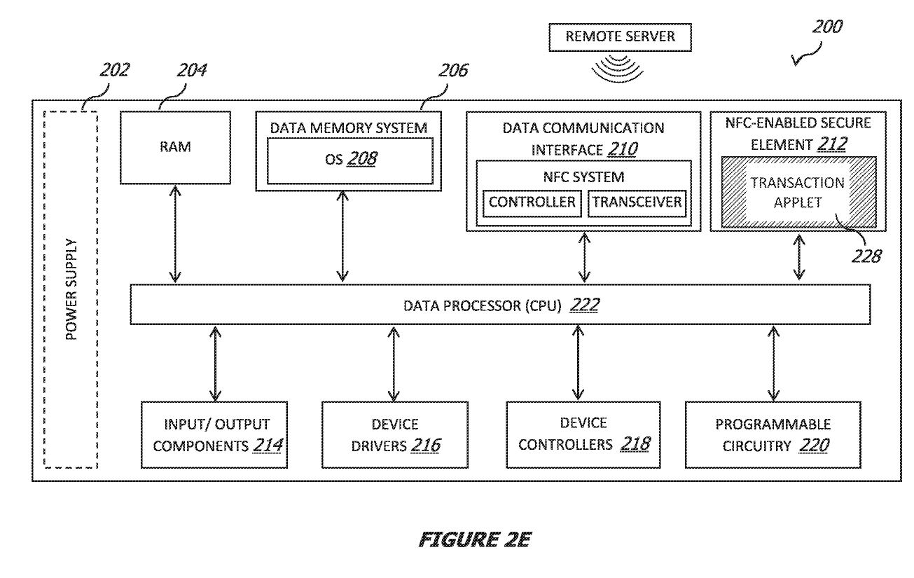

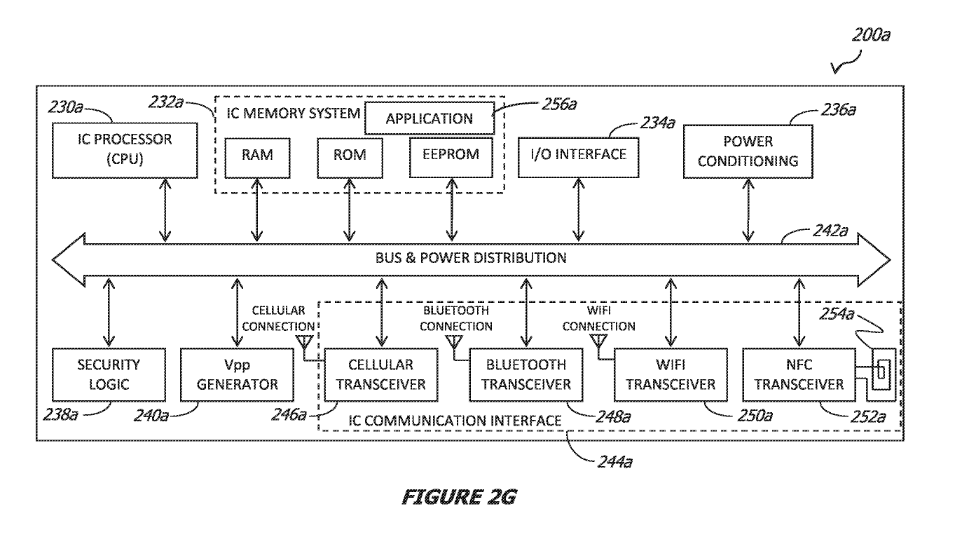

The further method, as illustrated in the flow diagram of FIG. 1A, is generally designated by reference numeral 100A. The method 100a starts with initiating, by a transaction device 200, 200a, a financial transaction process associated with the financial transaction and in response to a first input signal received at the transaction device 200, 200a (step 102a). The first input signal received at the transaction device 200, 200a may be a user generated input such as by way of touching, selecting, clicking, and the like. The first input signal may be processed by the transaction device 200, 200a in a manner that is well known in the art. Example configurations of the transaction device 200, 200a are separately illustrated in great details in FIGS. 2, 2A, 2C, 2E, and 2G of the present disclosure.

The method 100a may continue by generating, by the transaction device 200, 200a, a transaction authorization message in response to a second input signal received at the transaction device 200, 200a (step 104a). The second input signal received at the transaction device 200, 200a may also be a user generated input such as by way of touching, selecting, clicking, and the like. The transaction authorization message may include unique identifiers of at least a source transaction account, a recipient transaction account, and a secure transaction token. The recipient transaction account is distinct from the source transaction account. The secure transaction token may be associated with the source transaction account, and may be tracked by the distributed ledger system 400. The secure transaction token may represent a monetary value. The unique identifiers or IDs in the transaction authorization message uniquely identify one source transaction account from another source transaction account, one recipient transaction account from another recipient transaction account, and one secure transaction token from another secure transaction token.

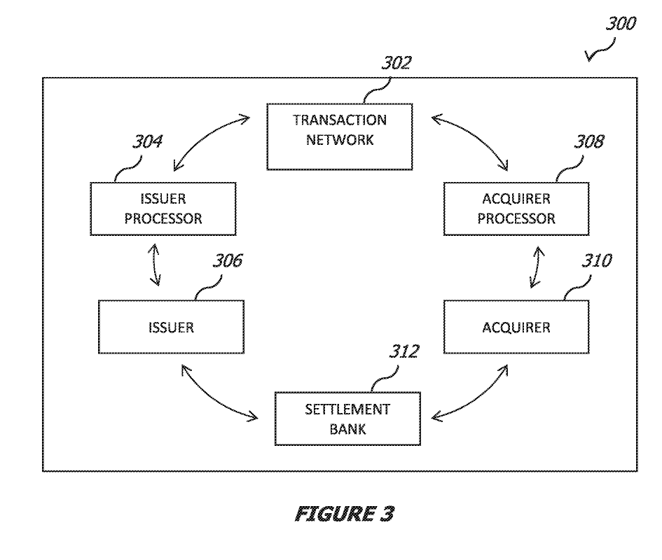

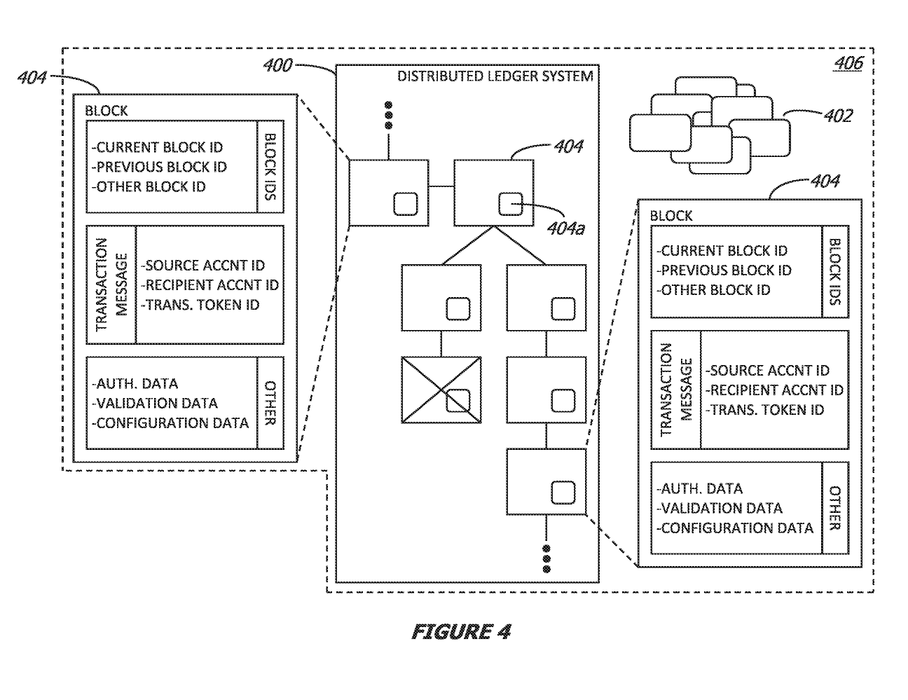

The method 100a may proceed with the transaction device 200, 200a transmitting the transaction authorization message to a transaction processing system 300 (step 106a) wherein the source transaction account is associated with the transaction processing system 300. Example components of the transaction processing system 300 are illustrated in great detail in the block diagram of FIG. 3. Once the transaction processing system 300 receives the transaction authorization message (step 108a), the transaction processing system 300 forwards the transaction authorization message to one or more distributed nodes 402 (step 110a). The one or more distributed nodes 402 may be located in a distributed network on which a distributed ledger system 400 resides and/or with which the distributed ledger system 400 is interfaced through any suitable API (application programming interface). Example components of the distributed ledger system 400 are illustrated in great detail in the block diagram of FIG. 4. Data communications among the transaction device 200, 200a, the nodes 402 associated with the distributed ledger system 400, the distributed ledger system 400 itself, and the transaction processing system 300 can be through any suitable data communication network such as the Internet.

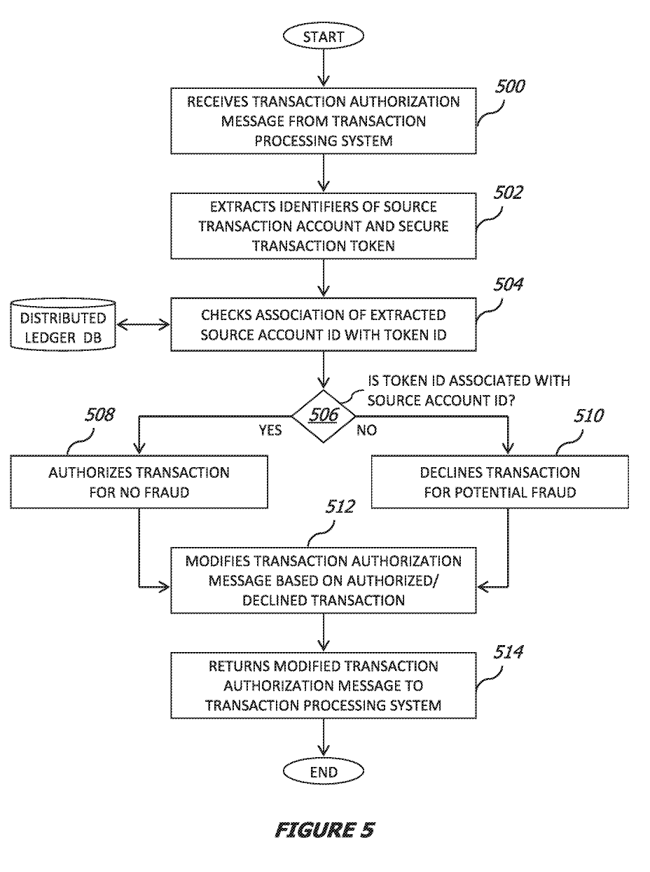

Receipt of the transaction authorization message by the nodes 402 from the transaction processing system 300 (step 112a) may trigger the nodes 402 to validate the association of the secure transaction token with the source transaction account (step 114a). An example validation process suitable for use in validating the association of the secure transaction token with the source transaction account is illustrated in the flow diagram of FIG. 5. The validation process may be executed on the distributed ledger system 400 by any preconfigured hardware and/or software resources associated with the distributed ledger system 400 and/or the nodes 402 in the distributed network. The validation process is illustrated in the flow diagram of FIG. 5. The validation process may begin with receiving the transaction authorization message from the transaction processing system 300 (step 500) and proceed with extracting identifiers of the source transaction account and the secure transaction token (step 502).

Whether the extracted source transaction account identifier (ID) and the extracted secure transaction token identifier (ID) are associated or matches one another is a query that can be answered by checking their association in a distributed ledger database associated with the distributed ledger system 400 (step 504). If the extracted source transaction account ID is associated with the secure transaction token ID based on the checking performed (decision step 506), the transaction characterized in the transaction authorization message is authorized for effectively no fraud (step 508). Otherwise, if the extracted source transaction account ID is not associated with the secure transaction token ID based on the checking performed (decision step 506), the transaction characterized in the transaction authorization message is declined for potential fraud (step 510). The extracted source transaction account ID may be determined to be associated with the secure transaction token ID if their association, pairing or coupling is pre-stored in the distributed ledger database.

The secure transaction token may be, or may include, one or more virtual currencies into which digital currency units may be integrated or incorporated and which can be used for electronic trading as a crypto-currency. In some embodiments, this crypto-currency may be stand-alone or, alternatively, a clone of another crypto-currency. In some embodiments, the secure transaction token may be, or may include, one or more asset-backed tokens. In some embodiments, the digital currency units that can be integrated or incorporated into the crypto-currency may be, by way of examples and not by way of limitation, any of Bitcoins, Metacoins, Peercoins, Appcoins, Quarkcoins, Namecoins, Dogecoins, and Litecoins. These virtual currencies may be decentralized; hence, no particular entity or node controls them. In order to ensure the integrity of these virtual currencies, established protocols, which are implemented as software algorithms, may be followed by participating entities or nodes for various transactions including currency production and exchange.

The validation process as illustrated in the flow diagram of FIG. 5 may further include modifying the transaction authorization message based on the authorized or otherwise declined transaction for no fraud or potential fraud, respectively (step 512). The modified transaction authorization message incorporating an indication of the authorized or otherwise declined transaction may then be returned to the transaction processing system 300 (step 514). The modified transaction authorization message is effectively based on whether the extracted source transaction account ID and the extracted secure transaction token ID are associated with one another which, in turn, proves the ownership of the secure transaction token with respect to the source transaction account.

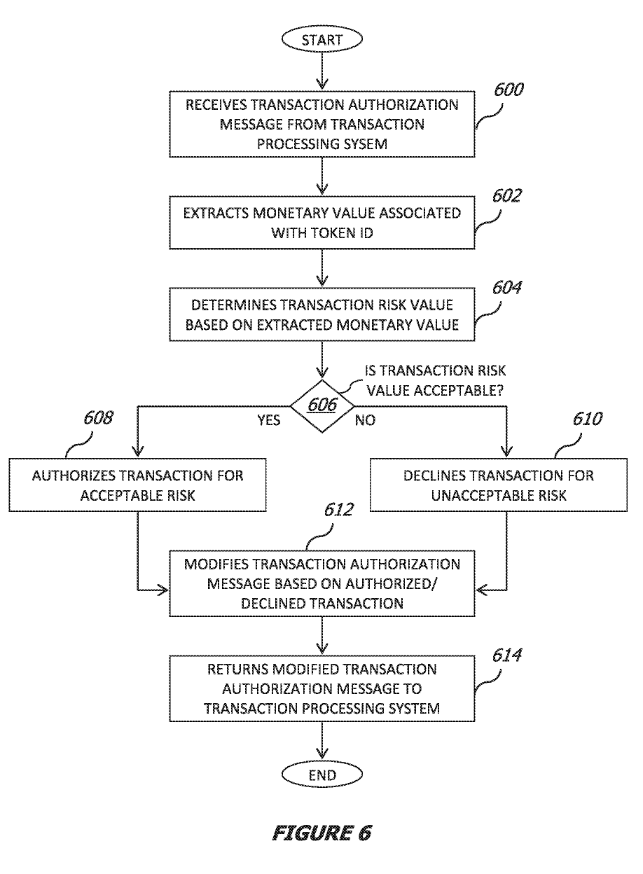

The validation process illustrated in FIG. 5 may also come with risk management sub-process in order to ensure that any potential risk associated with the transaction device-initiated financial transaction process is managed. The risk management sub-process is illustrated in the flow diagram of FIG. 6, and may be performed by any preconfigured hardware and/or software resources associated with the distributed ledger system and/or the nodes 402 which constitute the distributed ledger system 400. The risk management sub-process may begin with receiving the transaction authorized message which comes from the transaction processing system 300 and which originates from the transaction device 200, 200a (step 600). The monetary value associated with the secure transaction token ID which is incorporated or integrated into the transaction authorization message may then be extracted (step 602).

Based on the extracted monetary value, the transaction risk value that is effectively associated with the transaction authorization message may be consequently determined (step 604). If the transaction risk value is acceptable based on a preconfigured threshold (decision step 606), the risk management sub-process may proceed with authorizing the transaction for acceptable risk (step 608); otherwise, the risk management sub-process may proceed with declining the transaction for unacceptable risk (step 610). The transaction authorization message may be further modified based on the authorized or otherwise declined transaction (step 612), and the modified transaction authorization message is subsequently returned to the transaction processing system 300 (step 614) which is effectively based on any associated risk.

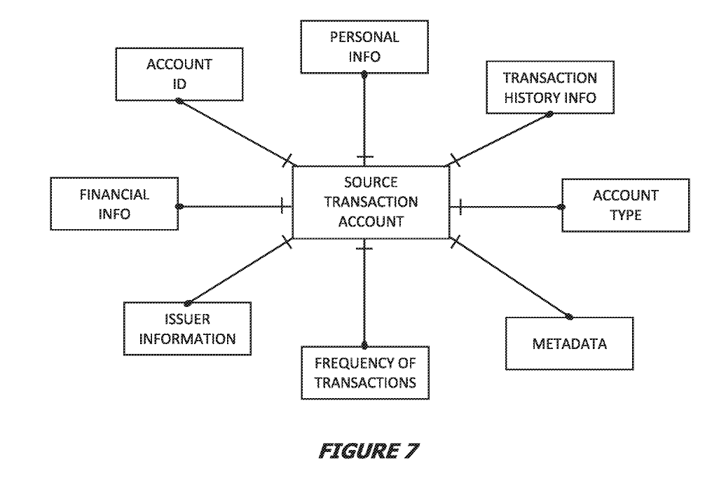

In some embodiments, the transaction validation process illustrated in FIG. 5 and the transaction risk management sub-process illustrated in FIG. 6 may consider various information such as account IDs, personal information, transaction history information, account type, financial information, issuer information, frequency of transactions, and metadata, to name but a few. These exemplary information which, in whole or in part, may be associated with the transaction source account can be utilized in performing or executing the validation process and the risk management sub-process are illustrated in the block diagram of FIG. 7.

In the event where the association of the secure transaction token with the source transaction account is successfully validated by the any one or more of the nodes 402 based on any one or more of the distributed ledgers within the distributed ledger system 400, the method 100a may progress to the step of transferring, by the distributed ledger system 400, the association of the transaction token from the source transaction account to the recipient transaction account based on the validation of the association of the transaction token with the source transaction account (step 116a) whereby first transfer data is generated based on the transferred association of the transaction token (step 118a). The first transfer data may then be routed by the distributed ledger system to the transaction processing system 400 (step 120a).

Receipt of the first transfer data by the transaction processing system 300 (step 122a) may trigger the transaction processing system to facilitates transfer of the monetary value from the source transaction account to the recipient transaction account based on the first transfer data (step 124a) whereby second transfer data is generated based on the transferred monetary value (step 126a). Subsequently, the transaction processing system 300 may be arranged to publish the second transfer data on the distributed ledger system 400 (step 128a) and send the second transfer data to the transaction device 200, 200a (step 130a). Finally, the transaction device 200, 200a may cause the second transfer data to be recorded on and retrievable on demand from the device-resident ledger system which resides on, or located in the hardware, software, and/or firmware resources of, the transaction device 200, 200a (step 132a). Alternatively, or in addition, the step of causing (step 132a) may be performed by the transaction processing system 300 over any well-known and suitable data communication network.

Referring now to FIGS. 2, 2A, 2C, 2E and 2G, there are shown block diagrams which illustrate different implementations of the transaction device 200, 200a which can be used for implementing the distributed, ledger-based processing and recording of the electronic financial transaction consistent with one or more aspects of the present invention. As shown in FIGS. 2, 2A, 2C, 2E, the transaction device 200 is preferably implemented as a data processing device such as a mobile phone which may generally include a power supply 202, a RAM (random access memory) 204, a data memory system 206 into which a mobile OS (operating system) 208 is loaded and operating, a data communication interface 210 for enabling the data processing device 200 to communicate with a remote server, a secure element 212, input/output components 214, device drivers 216, device controllers 218, a programmable circuitry 220, and a data processor 222 such as a CPU 222 which are in operative communication with one another through any appropriate system and local data buses.

In some embodiments, and consistent with the method 100, 100a of the present invention, the data memory 206 stores a transaction application 224 which, when executed by the data processor 222 from the data memory system 206, causes the data processor 222 to perform the steps of initiating (step 102a), generating (step 104a), transmitting (step 104a), and causing (step 132a), each of which is clearly illustrated in FIG. 1A. In one embodiment, step of transmitting (step 106a) utilizes the data communications interface 210 of the data processing device 200 to transmit the transaction authorization message to the one or more distributed nodes 402. In another embodiment, the step of causing (step 106a) utilizes the data communications interface 210 of the data processing device 200 to enable the recording of the second transfer data on the distributed ledger system 400.

Particularly, the data memory system 206 is in operative communication with the data processor 222, and the data communication interface 210 is coupled to the data processor 222. The data processing device 200 may further include the transaction application 224 stored on the data memory system 206 and which, when executed by the data processor 222 from data memory system 206, implements a method to, at least: (i) initiate the financial transaction process associated with the financial transaction and in response to the first input signal received at the data processing device 200; (ii) generate the transaction authorization message in response to the second input signal received at the data processing device 200, wherein the transaction authorization message includes the identifiers of at least the source transaction account, the recipient transaction account which is distinct from the source transaction account, and the secure transaction token associated with the source transaction account and representing the monetary value; and (iii) transmit, using the data communication interface 210, the transaction authorization message to the transaction processing system 300 with which the source transaction account is associated.

In the method implemented by the transaction application 224 incorporated into the data processing device 200, the transaction processing system 300 forwards the transaction authorization message to the one or more distributed nodes 402 located in the distributed network on which the distributed ledger system 400 resides, wherein the one or more distributed nodes 402 validates at least the association of the transaction token with the source transaction account based on the one or more distributed ledgers within the distributed ledger system 400.

Still in the method implemented by the transaction application 224 incorporated into the data processing device 200, the distributed ledger system 400 transfers the association of the transaction token from the source transaction account to the recipient transaction account based on the validation of the association of the transaction token with the source transaction account whereby the first transfer data is generated based on the transferred association of the transaction token. This first transfer data is routed by the distributed ledger system 400 to the transaction processing system 300. The transaction processing system 300 facilitates transfer of the monetary value from the source transaction account to the recipient transaction account based on the first transfer data whereby the second transfer data is generated based on the transferred monetary value.

Still in the method implemented by the transaction application 224 incorporated into the data processing device 200, the transaction processing system 300 publishes the second transfer data on the distributed ledger system 400, and the transaction processing system 300 sends the second transfer data to the data processing device 200. Consequently, the data processing device 200 causes the second transfer data to be recorded on and retrievable on demand from the device-resident ledger system which resides on the data processing device 200.

As clearly shown in FIG. 2 alone, the transaction application 224 may reside on the data memory system 206 of the transaction device 200 wherein the device-resident ledger system may likewise reside on the same data memory system 206. As clearly shown in FIG. 2A alone, the transaction application 224 may reside on the programmable circuitry 220 of the transaction device 200 wherein the device-resident ledger system may reside on any memory unit associated with the programmable circuitry 220. As clearly shown in FIG. 2C alone, the transaction application 224 may reside on the data memory system 206 of the transaction device 200 while an emulated transaction application 226 corresponding to the transaction application 224 may reside either on the secure element 212 which may be NFC (near field communication) enabled or on any remote server in operative communication with the transaction device 200, wherein the device-resident ledger system may reside on both of the data memory system 206 of the transaction device 200 or on the secure element 212. As clearly shown in FIG. 2E alone, the transaction application 224 can be in the form of a transaction applet 228 which may reside on the NFC-enabled secure element 212.

As shown in FIG. 2G alone, the transaction device 200a in accordance with one or more aspects of the present invention may be implemented as an integrated circuit (IC) device. The IC device 200a may be arranged to cooperatively communicate with the transaction device 200 illustrated in great details in FIGS. 2, 2A, 2C, and 2E. The IC device 200a may be incorporated into the transaction device 200. Alternatively, the IC device 200a may be linked to the transaction device 200. It is to be understood and appreciated that direct or indirect communications may be arranged between the IC device 200a and the transaction device 200 through any appropriate local circuitry or data communication network.

The IC device 200a may exist in the form of SIM (subscriber identity module) card that can be inserted into any electronic device or, particularly, any mobile communication device. The SIM card may include a SIM (subscriber identity module or subscriber identification module) that identifies the mobile communication device into which it may be inserted. The SIM card may also include its own CPU (central processing unit) or IC processor 230a, an IC memory system 232a which may include a RAM (random access memory), a ROM (read-only memory), and an EEPROM (electrically erasable programmable read-only memory), and an input/output interface 234a. Like the usual design of SIM cards known in the relevant art, the SIM card of the present invention may also include a power conditioning element 236a, a security logic 238a, and a Vpp (peak-to-peak voltage) generator 240a. These exemplary components of the SIM card may interact or communicate with one another through a bus and power distribution system 242a.

The IC device 200a, which may correspond to the secure element 212 of the transaction device 200 illustrated in FIGS. 2, 2A, 2C, and 2E, may be suitably arranged for implementing the electronic ledger-based processing and recording of an electronic financial transaction in the financial transaction consistent with another aspect of the present invention. Particularly, the IC memory system 232a is in operative communication with the IC processor 230a. The IC device 200a may also include an IC communication interface 244a which is coupled to the IC processor 230a. The IC device 200a in the form of the SIM card may also include its own cellular transceiver 246a, Bluetooth™ transceiver 248a, Wi-Fi transceiver 250a, and NFC transceiver 252a with antenna 254a, all of which may constitute the IC communication interface 244a. In this respect, the SIM card 200a may also facilitate NFC-based communications dependently or independently of the transaction device 200 that can be a mobile phone into which the same SIM card 200a may be inserted and may receive incoming electronic transactions from other data communication devices or computer systems.

In some embodiments, and consistent with the method 100, 100a of the present invention, the IC memory system 232a embeds a transaction application 256a which, when executed by the IC processor 230a from the IC memory system 232a, causes the IC processor 230a to perform the steps of initiating (step 102a), generating (step 104a), transmitting (step 106a) and causing (step 132a), each of which are clearly illustrated in FIG. 1A. In one embodiment, the step of transmitting (step 106a) utilizes the IC communications interface 244a to transmit the transaction authorization message to the one or more distributed nodes 402. In another embodiment, the step of causing (step 132a) utilizes the IC communications interface 244a to enable the recording of the second transfer data on the distributed ledger system 400.

In some embodiments, the IC device 200a which comprises the transaction application 256a stored on the IC memory system 232a may be caused to perform a method independently of the transaction device 200. The transaction application 256a, when executed by the IC processor 230a from the IC memory system 232a, implements such independent method to, at least: (i) initiate a financial transaction process associated with the financial transaction and in response to the first input signal received at the IC device 200a; (ii) generate the transaction authorization message in response to the second input signal received at the IC device 200a, wherein the transaction authorization message includes identifiers of at least the source transaction account, the recipient transaction account distinct from the source transaction account, and the secure transaction token associated with the source transaction account and representing the monetary value; and (iii) transmit, using the IC communication interface 244a, the transaction authorization message to the transaction processing system 300 with which the source transaction account is associated.

In the method implemented by the transaction application 256a incorporated into the IC device 200a, the transaction processing system 300 forwards the transaction authorization message to the one or more distributed nodes 402 located in the distributed network on which the distributed ledger system 400 resides. The one or more distributed nodes 402 validates at least the association of the transaction token with the source transaction account based on the one or more distributed ledgers within the distributed ledger system 400. The distributed ledger system 400 transfers the association of the transaction token from the source transaction account to the recipient transaction account based on the validation of the association of the transaction token with the source transaction account whereby the first transfer data is generated based on the transferred association of the transaction token.

Still in the method implemented by the transaction application 256a incorporated into the IC device 200a, the distributed ledger system 400 routes the first transfer data to the transaction processing system 300. The transaction processing system 300 facilitates transfer of the monetary value from the source transaction account to the recipient transaction account based on the first transfer data whereby the second transfer data is generated based on the transferred monetary value. The transaction processing system 300 publishes the second transfer data on the distributed ledger system 400, and sends the second transfer data to the IC device 200a. In response to receipt of the second transfer data by the IC device 200a, the IC device 200a causes the second transfer data to be recorded on and retrievable on demand from a device-resident ledger system which resides in general on the IC device 200a but more particularly on the IC memory system 232a of the IC device 200a. The IC device 200 may also be utilized as the transaction device 200 which forms part of the computer-implemented method 100, 100a of implementing the distributed ledger-based processing and recording of an electronic financial transaction in the financial transaction.

In some embodiments, and consistent with the method 100, 100a of the present invention, the IC device 200a is in operative communication with a data processing device 200 which comprises the data processor 222, the data memory system 206 which is in operative communication with the data processor 222, and the data communications interface 210 coupled to the data processor 222. The IC memory system 232a embeds the transaction application 256a. The transaction application 256a, when executed by the data processor 222 from the IC memory system 232a, causes the data processor 222 to perform the steps of initiating (step 102a), generating (step 104a), transmitting (step 106a), and causing (step 132a), each of which are clearly illustrated in FIG. 1A. In one embodiment, the step of transmitting (step 106a) utilizes the data communications interface 210 of the data processing device 200 to transmit the transaction authorization message to the one or more distributed nodes 402. In another embodiment, the step of causing (step 132a) utilizes the data communications interface 210 of the data processing device 200 to enable the recording of the second transfer data on the distributed ledger system 400.

Referring now to FIG. 3, there is shown in great detail the example components of the transaction processing system 300. The transaction processing system 300 may be characterized by a payment transaction, and may include a transaction network 302 which connects an issuer processor 304 associated with an issuer 306 and an acquirer processor 308 associated with an acquirer 310. The example transaction processing system 300 may also include a settlement bank 312. It is to be understood and appreciated that these components, and as well as their communication arrangements, which are associated with the transaction processing system 300, are merely exemplary for the purpose of illustrating the manner by which transactions can be carried out according to one or more embodiments of the present invention, and that the same components and their communication arrangements in a transaction system may vary depending on the type and nature of the financial transactions involved (e.g., lending, insurance, investment).

Referring now to FIG. 4, there are shown example components of the distributed ledger system 400 illustrated in great details. The distributed ledger system 400 mainly comprises the nodes 402 which may reside, for example, on a peer-to-peer network 406. The distributed ledgers which may constitute the distributed ledger system 400 may be of secure type and distributed among the nodes 402 in the peer-to-peer network 406, wherein a common set of procedures are followed by the nodes 402 in order to mitigate any uncertainties, risks and distrust which may arise between two of the nodes 402 or among three or more of the nodes 402.

Since the nodes 402 are likely not affiliated with one another, may be located remotely in respect of one another, may be used to perform electronic transactions in the peer-to-peer network 406 in an anonymous manner, do not come with centralized governance and control to prevent, address, or resolve any potential disputes, and are vulnerable to computer hackers, cyber-terrorists, viruses, adware, spyware and/or other malicious or harmful computer program codes, uncertainties, risks and distrust among the entities in the peer-to-peer network 406 are inherent. However, owing to the public nature of the distributed ledger system 400, each of the nodes 402 is able to monitor and, in fact, obtain and keep a copy of any of the distributed ledgers within the distributed ledger system 400, transparency is maintained at the peer-to-peer network 406. This transparency substantially mitigates any uncertainties, risks and distrust that may occur among the nodes 402.

The distributed ledgers which may constitute the distributed ledger system 400 may be maintained by the nodes 402 in a collective manner within the peer-to-peer network 406 which is a secure distributed network. Hence, these distributed ledgers are secure decentralized distributed ledgers or transaction ledgers which are otherwise known are block chain. The distributed ledger system 400, in this regard, may be decentralized and based on blockchain technology. The block chain may include various blocks 404 which are linked to one another and which may carry transaction messages 404a that can be validated by the distributed ledger system 400. The transaction messages 404a may be correspond to the transaction authorization message generated using the transaction device 200, 200a, and the monetary value that is associated with the transaction messages 404a is guaranteed by the issuer 306, which may be a financial institution such as a bank, as illustrated in the exemplary transaction or payment processing system 300 of FIG. 3. Since the issuer 306 is guarantees the monetary value that is associated with the source transaction account owned by a subscriber and hence the balance associated with the source transaction account is known and/or available on-demand to the subscriber, the subscriber can authorize the financial transaction process initiated using the transaction device 200, 200a.

In some embodiments, the block chain may be used to enable entities in the peer-to-peer network 406 to communicate with one another in respect of electronic transactions which may be financially related electronic transactions. These communications, along with electronic exchanges of the transaction messages 404a among the entities in the peer-to-peer network 406 through the distributed ledger system 400, come with technical advantages and benefits. Firstly, the transaction messages 404a, which are individually and may be uniquely associated with the blocks 404, can be freely transmitted from any one of the nodes 402 to another one of the nodes 402, from any one of the nodes 402 to any two or more of the nodes 402, and from any two or more of the nodes 402 to any one of the nodes 402; hence, transparency is guaranteed. Secondly, the transaction messages 404a are not governed by a central authority which has the capability of maliciously altering the data or content associated with one or more of the distributed ledgers within the distributed ledger system 400 all at once. Thirdly, no one of the blocks 404 carrying the transaction messages 404a can be altered, obliterated, obfuscated or removed in whatsoever manner thereby substantially reducing, if not completely eliminating, fraudulent events. Fourthly, preventing any one or more of the nodes 402 from accessing any one or more of the distributed ledgers in the distributed ledger system 400 by another one or more of the nodes 402 is too complex, if not nearly impossible, to perform; hence, any one or more of the nodes 402 can be used to transact in a hassle-free manner, not to mention discrete and private manner. Lastly, but certainly not of least importance, posting and exchanges of the transaction messages 404a in the distributed peer-to-peer network 406 can be performed in a scheduled manner thereby giving the participating entities flexibility or resiliency in both operation and management (e.g., later retrieval of messages and records).

In some embodiments, receiving the transaction messages 404a from or sending the transaction messages 404a to one of the nodes 402 or a plurality of the nodes 402 may be performed using the block chain which characterize the distributed ledger system 400. In performing these receiving and sending functions, each one of the blocks 404 containing the transaction message 404a in the block chain may utilize various information which may be include, but certainly not limited to, identifiers associated with the blocks 404 (e.g., current block ID, previous block ID, and other block ID), identifiers associated with the transaction message 404a (e.g., source account ID, recipient account ID, and transaction token ID), and other data such as authentication data, validation data, and configuration data. Any one or more of these information may be recorded on, and can be made retrievable on demand from, any one or more of the distributed ledgers within the distributed ledger system 400.

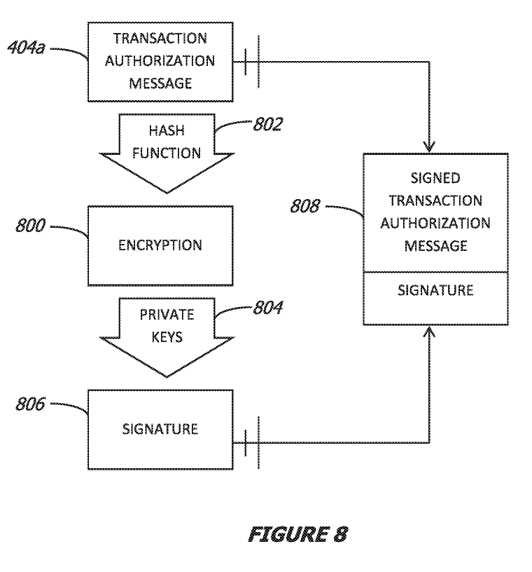

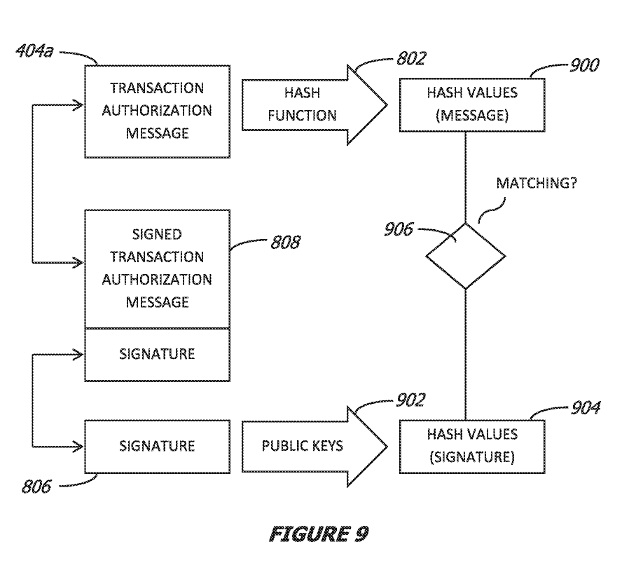

Referring to FIGS. 8 and 9, there are shown high level block diagrams which collectively illustrate a process for authenticating a transaction suitable for use in one or more aspects or embodiments of the present invention. In particular, FIG. 8 illustrates a first component of the authentication process which can be performed by an authenticated party (e.g., by a subscriber who operates the transaction device 200, 200a and use it to initiate a transaction) while FIG. 9 illustrates a second component of the authentication process which can be performed by an authenticating party (e.g., entity who is authorized to validate the transaction messages 404a and to add at least one block 404 in the block chain based on the validated transaction messages 404a.

As illustrated in FIG. 8 alone, the transaction message in general or the transaction authorization messages in particular 404a may undergo an encryption process 800 by way of applying a hash function 802. In one embodiment, the transaction message 404a may be digitally signed by the subscriber or the sender of the same transaction message 404a using his or her private keys 804. Those skilled in the art shall recognize well-known methods and techniques that can be used to affix the signature 806 to the transaction message 404a for the purpose of utilizing the hash function 802 and the private keys 804 in generating a signed transaction message 808. The signed transaction message 808 ensures integrity of the data which are associated with the transaction message 404a which are subject to validation by the one or more distributed nodes 402 located, for example, in the distributed peer-to-peer network 406.

In FIG. 9 alone, the authenticating party may be enabled to extract, using the hash function 802, a first set of hash values 900 from the transaction authorization message 404a which is derived from the signed transaction authorization message or the transaction authorization message 808 that is digitally signed. Simultaneously, or one after the other, the authenticating party may also be enabled to extract, using public keys 902, a second set of hash values 904 from the signature 806 which is derived from the signed transaction authorization message or the transaction authorization message that is digitally signed 808. At decision step 906, the first set of hash values 900 and the second set of hash values 904 may be compared with one another to determine if they are matching with one another. A matching set of the hash values 900, 904 may be an indicator that the signed transaction authorization message 808 is authentic in relation to the source transaction account used to generate the same signed transaction authorization message 808. Otherwise, a mismatching set of the hash values 900, 904 may be an indicator that the signed transaction authorization message 808 is not authentic and is potentially generated through fraudulent activities.

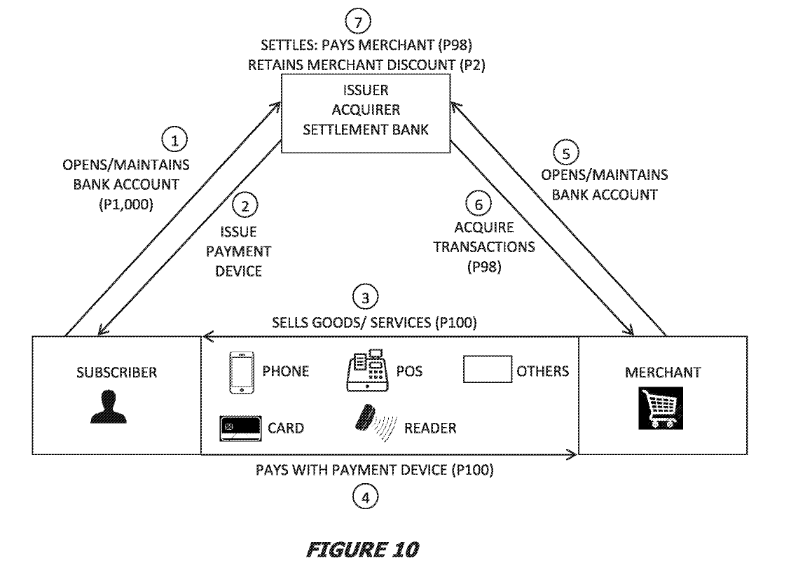

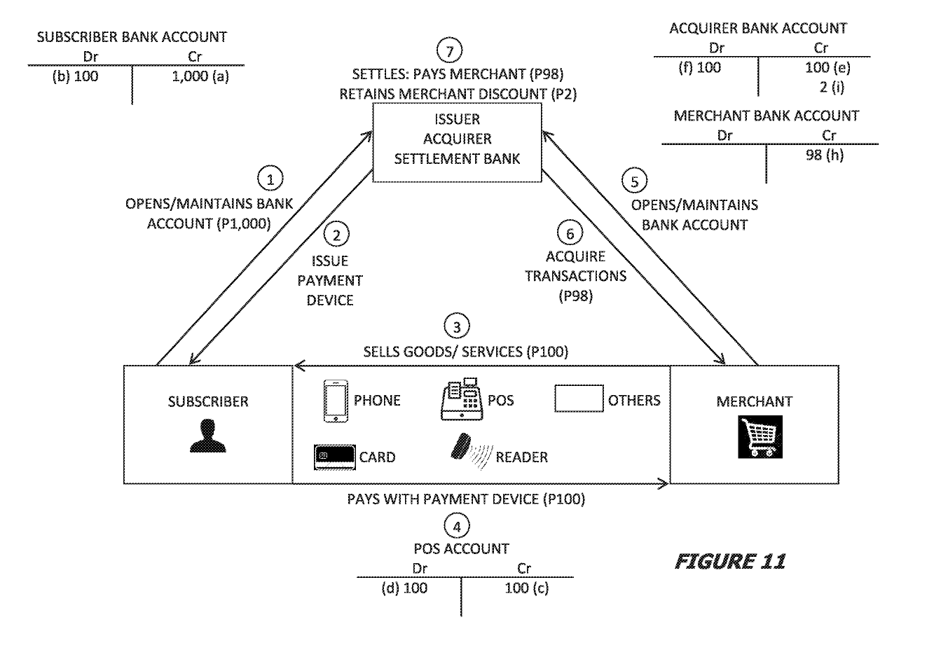

Referring now to FIGS. 10 and 11, there are shown flow diagrams illustrating, respectively, an example closed loop payment process and an example detailed closed loop payment process suitable for use in one or more aspects of the invention. The first step (step 1) of the payment flow may be opening and/or maintaining, by a subscriber, a bank account with an issuer which may form part of the payment processing network. The second step (step 2) of the payment flow may be issuing the transaction device or payment device, by the issuer, to the subscriber. The third step (step 3) of the payment flow may be characterized by a merchant selling goods and/or services to the subscriber. The fourth step (step 4) of the payment flow may be characterized by the subscriber paying for the goods and/or services offered by the merchant using his or her payment device as issued by the issuer. The fifth step (step 5) of the payment flow may be opening and/or maintaining, by a merchant, a bank account with an acquirer which may form part of the payment processing network. The sixth step (step 6) of the payment flow is acquiring of the transaction along with the monetary value accompanying the same transaction. The seventh step (step 7) of the payment flow is settlement.

As illustrated in FIG. 11 alone, the merchant sells the goods and/or services to the subscriber at One-Hundred Philippine Pesos (PhP100.00) or approximately Two Dollars (USD2.00). Consequently, the subscriber pays the same amount, PhP100.00, through the payment processing network which may include the issuer, the acquirer, the issuer's and acquirer's processors, and the settlement bank. The subscriber specifically pays the merchant the amount of PhP100.00 from his bank account which maintains a disposable fund of PhP1,000.00. In the processing the payment transaction, a merchant discount of, for example, PhP2.00 may be deducted from the transaction amount of PhP100.00. The transaction records produced by this exemplary payment transaction may be recorded on the ledger systems associated with the subscriber's account, the merchant's bank account, and the acquirer's bank account taking into consideration the transaction amount of PhP100.00 and the merchant discount of PhP2.00. Any one or more of these ledgers may be recorded on the distributed ledger system 400 of the present invention through any suitable communication links among the subscriber's payment device, the merchant's POS (point-of-sale) system, and the payment processing network's computer systems. The ledger associated with the subscriber's account may also be recorded on the device-resident ledger system which is preferably stored on the subscriber's payment device and is preferably tracked by the distributed ledger system 400 in accordance with one or more aspects of the present invention.

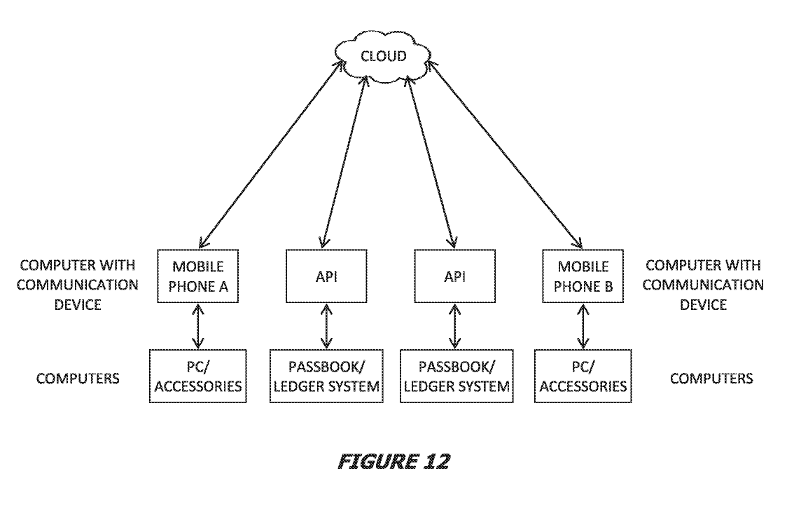

FIG. 12 is a high level block diagram illustrating an exemplary data communication network suitable for use in the one or more aspects of the invention. The data communication network may facilitate data communications between and/or among the transaction device 200, 200a, the transaction processing system 300 which may be a payment processing system 300, and the distributed ledger system 400 of the several aspects of the present invention. In some embodiment, the data communication network may be a cloud type of network which may be used to enable data communications between two computers with communication devices. The computers may be used to access the one or more ledger systems through any suitable API or application programming interface which can be customized depending on the configurations of any one or more of the transaction device 200, 200a, the transaction processing system 300 which may be a payment processing system 300, and the distributed ledger system 400 of the present invention.

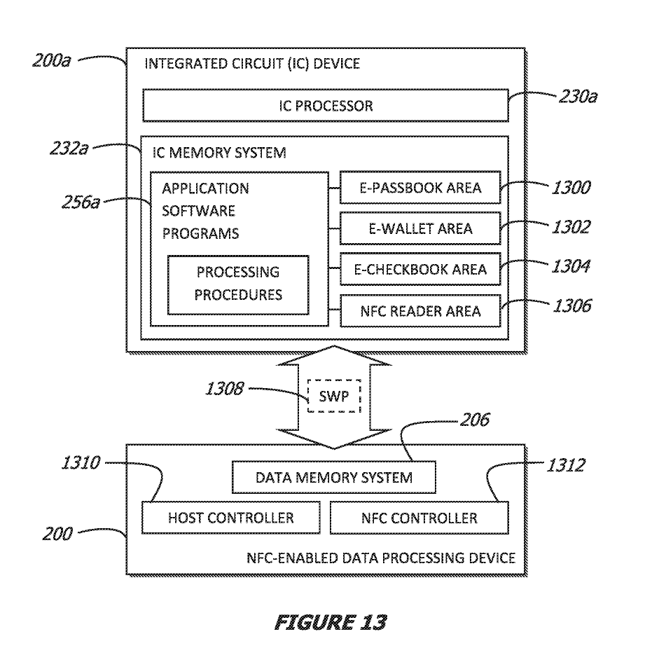

Referring now to FIG. 13, there is shown a block diagram illustrating the components of the electronic integrated circuit (IC) device in accordance with one or more preferred implementations of the present invention. The IC device 200a is suitable for use generally in any electronic and computer-implemented financial transaction processing system and specifically in implementing ledger-based processing and recording of an electronic financial transaction.

The IC device 200a includes an IC memory system 232a and a plurality of application software programs 256a allocated to the IC memory system 232a.

Each of the application software programs 256a preferably contains processing procedures which are executable for performing a near-field communication (NFC)-based outgoing transaction. The processing procedures may be interchangeably referred to herein as the “application software programs” 256a containing the processing procedures or simply “applications” for ease of comprehension.

The NFC-based outgoing transaction may use any of an electronic passbook (e-passbook) account, an electronic wallet (e-wallet) account, and an electronic checkbook (e-checkbook) account of an account holder. The account holder may be a human user and/or owner of the e-passbook, e-wallet, and e-checkbook accounts.

The IC device 200a preferably includes an e-passbook account information area 1300 of the IC memory system 232a for storing information about the e-passbook account incident to or based on any one or more of the processing procedures and associated with the application software programs 256a stored on the IC memory system 232a.

The IC device 200a preferably includes an e-wallet account area 1302 of the IC memory system 232a for storing information about the e-wallet account incident to or based on any one or more of the processing procedures and associated with the application software programs 256a stored on the IC memory system 232a.

The IC device 100 preferably includes an e-checkbook account area 1304 of the IC memory system 232a for storing information about the e-checkbook account incident to or based on any one or more of the processing procedures and associated with the application software programs 256a stored on the IC memory system 232a.

The IC device 100 preferably includes an NFC reader area 1306 of the IC memory system 232a for reading an NFC-based incoming transaction request and associated with the application software programs 256a stored on the IC memory system 232a. The incoming transaction request may originate from a third-party electronic device. The third-party electronic device may also be NFC-enabled.

The IC device 200a is preferably configured to communicate, via a single wire protocol connection 1308, with an NFC controller 1312 of the NFC-enabled data processing device 200 in which the IC device 200a can be inserted and made operable.

The single wire protocol 1308 connection may be based on ETSI (European Telecommunications Standards Institute) specifications. Preferably, gates, pipes, registries, commands, responses and events characterizing the connection of the SIM card characterizing the IC device 200a to a CLF (contactless frontend) interface may be defined by ETSI HCL (Host Controller Interface) specifications.

Preferably, the IC device 200a includes the IC processor 230a in communication with the IC memory system 232a, and the processing procedures which are associated with the application software programs 256a stored on the IC memory system 232a are executable by the IC processor 230a of the IC device 200a.

Preferably, the IC device 200a includes a host controller 1310, and the processing procedures which are associated with the application software programs 256a stored on the IC memory system 232a are executable by the host controller 1310 of the NFC-enabled data processing device 200 in which the IC device 200a can be inserted and made operable for performing various functions and services.

The NFC-enabled data processing device 200 may include a machine-readable data memory system 206 that is in operative communication with the host controller 1310.

Any of the information about the e-passbook account, the e-wallet account, and the e-checkbook account can be stored, by the host controller 1310, in the machine-readable data memory system 206 of the NFC-enabled data processing device 200.

In one or more preferred implementations of the present invention, the IC device 200a has a form factor which may be selected from a group consisting of a SIM (subscriber's identification module) card, UICC (universal integrated circuit card), embedded SE (secure element) card, smart SD (secure digital) card, and smart micro SD (secure digital) card.

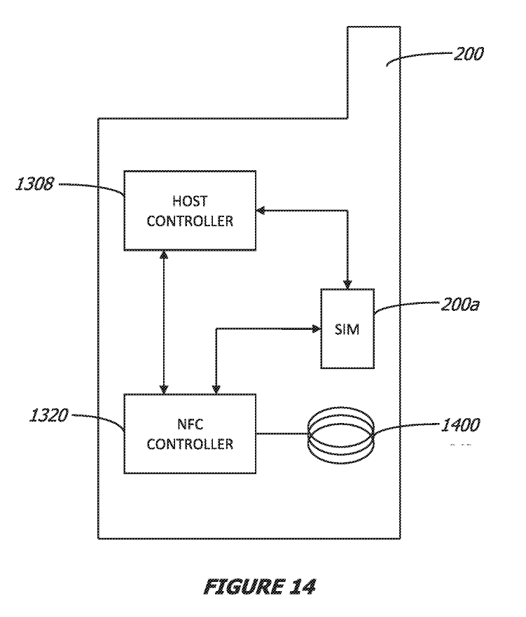

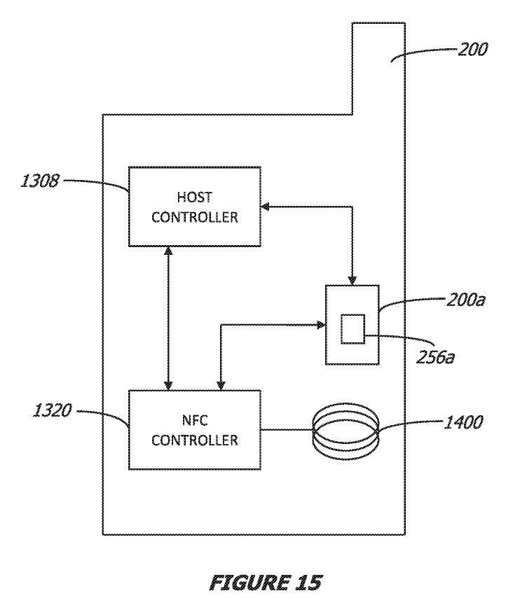

Referring to FIGS. 14 and 15, there are shown, respectively, a block diagram illustrating the electronic data processing device 200 with the NFC-enabled IC device 200a, and a block diagram illustrating electronic data processing device 200 with the NFC-enabled IC device 200a having a plurality of the application software programs 256a.

It is to be understood and appreciated that all interactions by and between parties and/or entities in the financial transaction processing system that will be illustrated in the ensuing description of the preferred implementations of the present invention are computer-based, computer-assisted and/or computer-implemented.

It is also to be understood and appreciated that any segment of or the entire processing procedures associated with the application software programs 256a may be designed using any suitable programming language, such as Java, and based on the computer-implemented interactions between parties and/or entities in the financial transaction system that will be described in the ensuing description of preferred embodiments and/or implementations of the present invention.

As such, the financial transaction system as may be illustrated in the herein disclosure of the present invention may include computer systems or network of computers associated with a merchant, a SIM card issuer such as a telecommunication company (Telco), and a financial institution such as a bank.

The IC device 200a may be a machine substrate characterized by an NFC-enabled machine substrate. Preferably, the NFC-enabled machine substrate is in the form of the aforementioned SIM card 200a. The application software programs 256a are preferably embedded into the SIM card 200a as applets or emulated applications.

The SIM card 200a, which may also be in the form of micro-SIM, may include an integrated circuit embedded in a removable plastic card that can be inserted into the NFC-enabled data processing device 200. The data processing device 200 may be a phone, a smart-phone, a tablet, a phablet, or any other similar computing and/or communication device.

The SIM card 200a may securely store the following information: unique serial number (ICCID) information; international mobile subscriber identity (IMSI) information; security authentication and ciphering information; information related to the local network; information associated with list of services the user has access to; and two password information: PIN (personal identification number) information and PUK (personal unblocking code) information.

The SIM card 200 may also serve as storage for special application programs and data (e.g., telephone directories).

As illustrated, the SIM card 200 is attached as a secure element to the NFC controller 1320 with an antenna 1400 of the electronic data processing device 200. The NFC controller 1320 with the antenna 1400 is attached to the host controller 1308 of the data processing device 200. The data processing device 200 preferably has access to a secured data communication network.

The programs 256a for the e-passbook, e-wallet, and e-checkbook and as well as the NFC Reader may be embedded in the SIM card 200a or any of its derivative device that is embedded and made operable on the data processing device 200 having the NFC controller 1320 attached to the antenna 1400.

The NFC controller 1320 is attached to the host controller 1308 that allows the transaction to be connected on the data communication network. The data communication network may be linked to a plurality of remote server computers.

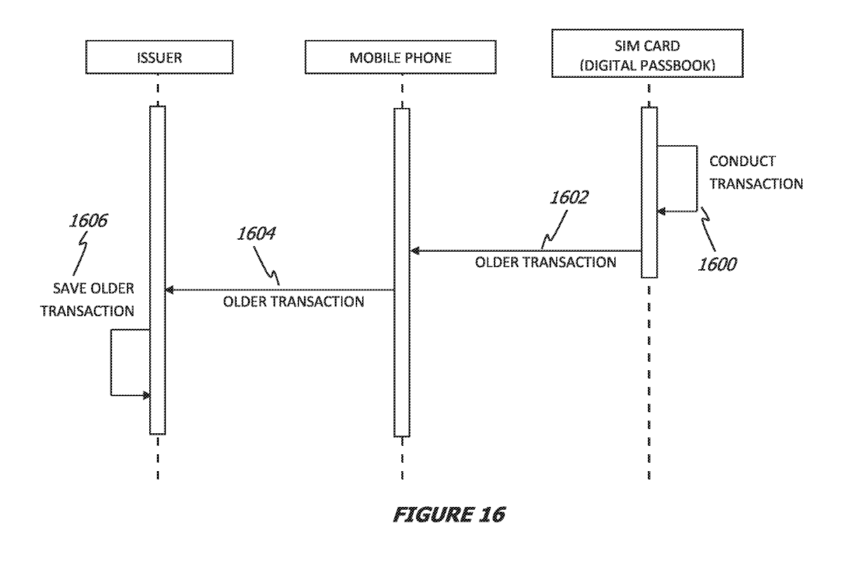

Referring to FIG. 16, there is shown a flow diagram illustrating a process for operating application programs containing processing procedures executable for performing an NFC-based outgoing transaction using an e-wallet account in relation to an e-passbook account. The e-passbook application embedded in the SIM card corresponds to a bank's statement of account for the subscriber's financial transactions in his e-wallet account.

The statement of account preferably contains the following features and/or information: (i) transaction date and time; (ii) unique transaction number; (iii) transaction code which describes the banking or financial transaction; (iv) debit column for payments or withdrawals; (v) credit column for deposits or loads (“deposits”); (vi) balance or outstanding balance of the subscriber's deposit; and (vii) remarks for additional description or instruction.

After the subscriber has conducted a transaction, as depicted by the flow of the arrow 1600, the SIM card downloads the older transaction to the electronic device such as a mobile phone, as depicted by the flow of the arrow 1602. The downloaded older transaction in the mobile phone is subsequently uploaded to a computer system of an issuer, as depicted by the flow of the arrow 1604. This process may be used to ensure completeness of transactions, prevent overloading, and enable reliable auditing.

Finally, the computer system of the issuer archives or saves in its data storage system the uploaded transaction, as depicted by the flow of the arrow 1606.

The e-wallet application embedded in the SIM card preferably enables the subscriber to: (i) accept deposits or money in his e-wallet; (ii) pay for goods and/or services he purchased from a merchant; and/or (ii) transfer funds from his e-wallet account to and from another e-wallet account.

The e-wallet account can take multi-currencies (e.g. Dollar, Pesos, Yen) and multi-tokens (e.g., stored values, chits, loyalty points). The e-wallet account may also be used for performing cross-border transactions. For example, the SIM card may be issued in one country (e.g., Philippines) but it can also be used to purchase goods and avail services in another country (e.g., Japan).

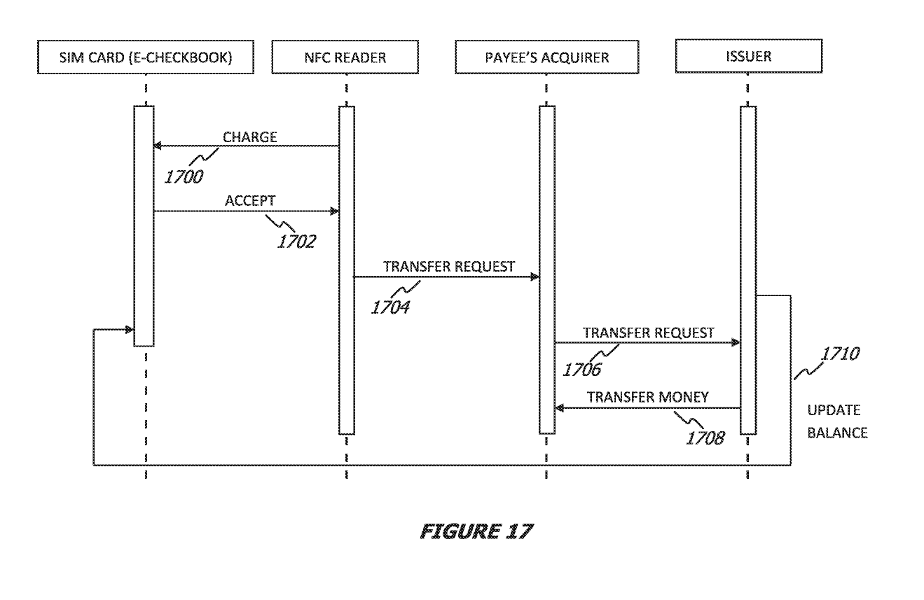

Referring to FIG. 17, there is shown a flow diagram illustrating a process for operating an application program containing processing procedures executable for performing an NFC-based outgoing transaction using an e-checkbook account.

The e-checkbook application, which is embedded in the SIM card that can be made operable on any suitable electronic device, preferably enables the subscriber (acting as a “payor”) to order payment of money from his deposit account with the SIM card issuer (acting as a “drawee”) to another party (acting as a “payee”).

The payor and the payee may be natural person or juridical or legal entity. The SIM card issuer may have a computer system and may be a bank or telecommunication company with which the subscriber has a credit, debit and/or pre-paid account.

The e-checkbook, upon issuance, is configured to reflect the balance of the credit, debit, or pre-paid account that the subscriber may want to use to pay for goods and/or services he wants to purchase from a merchant or an individual.

By tapping his SIM card on an NFC reader, the subscriber in effect accepts the charges by the seller (acting as the “merchant” or the “individual”) for goods and/or services purchased by the subscriber from the seller, as depicted by the flow of the arrows 1700 and 1702.

By tapping the subscriber's SIM card on the NFC reader, the subscriber also allows the transfer of money from his issuer account to a payee's acquirer, as depicted by the flow of the arrows 1704, 1706 and 1708.

By tapping the subscriber's SIM card on the NFC reader, the subscriber in effect instructs the computer system of his issuer to pay for the goods and/or services he purchased or to transfer the money from his account to the account of the merchant.

As it becomes apparent that the e-checkbook is the replacement of a regular checkbook, all the rules and regulations pertaining to the regular checks may apply to all payment orders coming from the e-checkbook account.

Using the e-checkbook account, all variants of checks or payment orders currently used in the banking system can be issued. From time to time, the computer system of the issuer updates the balance on the e-checkbook account, as depicted by the flow of the arrow 1710.

The NFC reader is an application program for reading NFC transactions or messages and is also preferably embedded in the SIM card. With the NFC reader in the SIM card 200a, phone-to-phone banking and financial transactions can be performed.

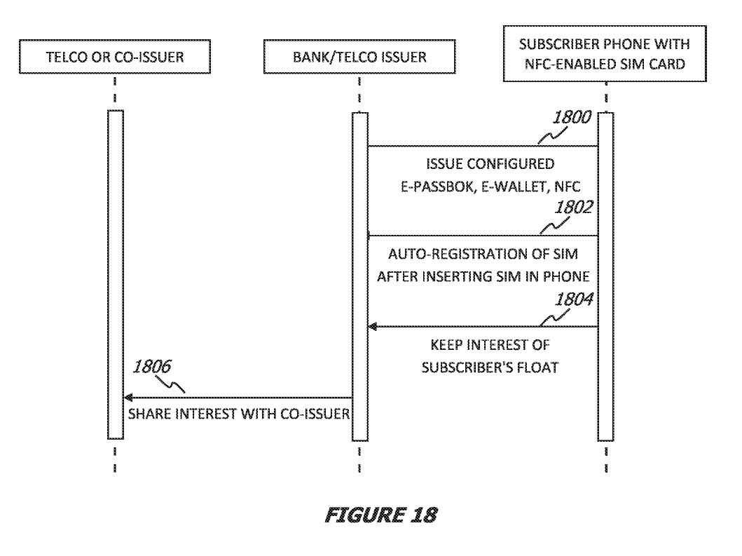

Referring to FIG. 18, there is shown a flow diagram illustrating a process for issuing the IC device 200a. The issuer issues the SIM card that comprises the application software programs for e-passbook, e-wallet and NFC Reader to a subscriber, as depicted by the flow of the arrow 1800.

Upon insertion of the SIM card on any suitable electronic device, it automatically registers to the issuer, as depicted by the flow of the arrow 1802.

The issuer may be a telephone company (“Telco”) or a bank. The Telco may also act as co-issuer. The issuer may generally keep the “float” of the digital passbook account or the un-utilized funds that are deposited in the digital passbook accounts of all subscribers, as depicted by the flow of the arrow 1804.

One subscriber may use that “float” to settle all payment instructions of the subscribers for goods and services they purchased.

The issuer may also enjoy the interest it earns on the “float.” The co-issuer may share part of the income of the issuer, as depicted by the flow of the arrow 1806.

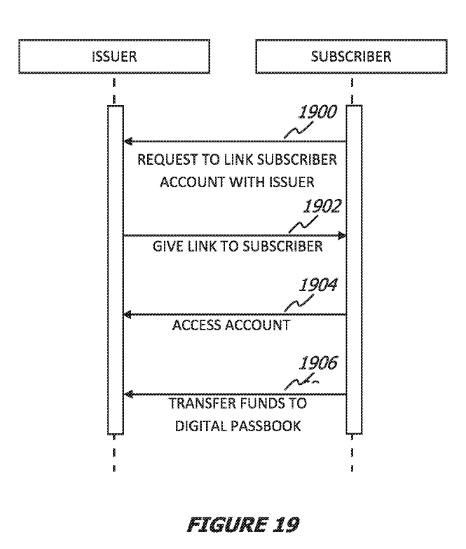

Referring to FIG. 19, there is shown a flow diagram illustrating a process for linking the integrated circuit device of FIG. 13 to a subscriber's issuer accounts. When the issuer issues the SIM card to the subscriber, the issuer may give the subscriber the option to link his SIM card to his issuer or bank accounts (“issuer accounts”), as depicted by the flow of the arrow 1900. The bank accounts may be a credit, a debit, or a pre-paid account.

To link the subscriber's SIM card to his issuer accounts, the subscriber may register his e-passbook and e-wallet accounts via encrypted SMS (short messaging service) or secured TCP/IP connection using his mobile phone or any suitable electronic device.

Upon validation, the issuer may link the subscriber's SIM card with his issuer accounts, as depicted by the flow of the arrow 1902. By linking his SIM card to his issuer accounts, the subscriber may be able to access his issuer accounts, as well as transfer funds from his issuer accounts to his e-wallet application, as depicted by the flow of the arrows 1904, 1906, respectively.

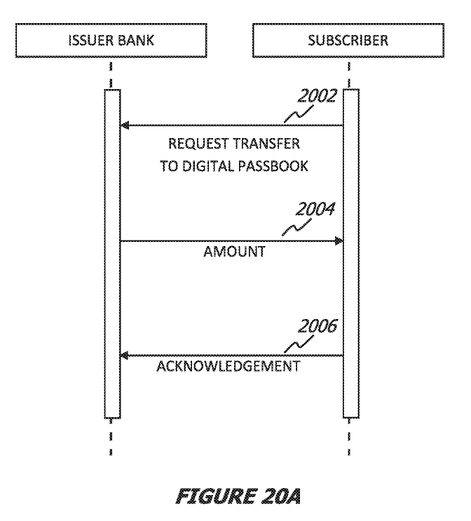

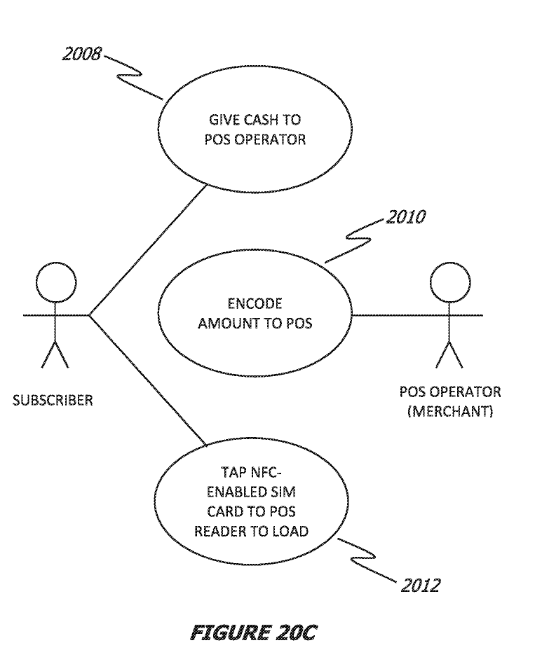

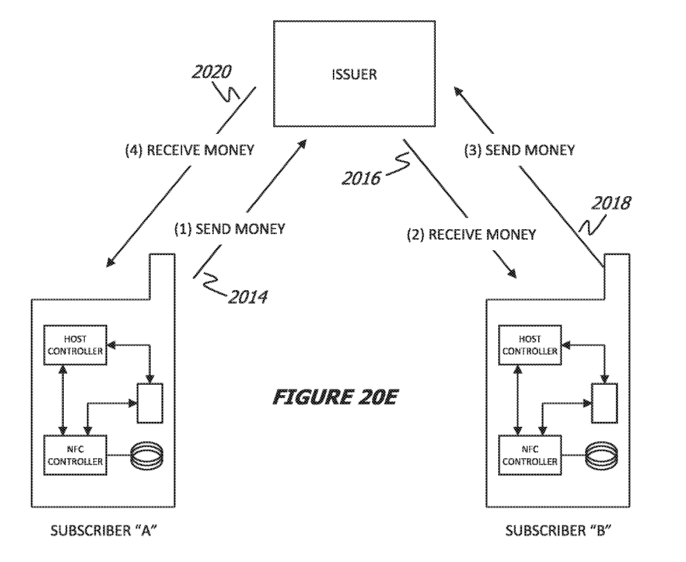

FIGS. 20A, 20C and 20E are flow diagrams illustrating processes for loading the electronic wallet account via OTA (over-the-air), via OTC (over-the-counter), and via phone-to-phone, respectively. In sum, the subscriber can load his digital passbook account in three (3) ways: either (i) via the OTA; or (ii) via the OTC; or (iii) via the phone-to-phone communication channels.

To use the OTA transfer as particularly illustrated in FIG. 8A alone, the subscriber may instruct his issuer to transfer some deposits from his issuer accounts (e.g., credit, debit or pre-paid account) to his e-wallet account via encrypted SMS or secured TCP/IP (Transmission Control Protocol/Internet Protocol) connection using any suitable electronic device, as depicted by the flow of the arrows 2002, 2004, and 2006.

For bigger amounts, the bank or Telco accounts may ask for the subscriber's PIN (personal identification number). For security, loading the e-wallet account via the OTA transfer may be conducted online or through any secure communication channel.

To use the OTC transfer as particularly illustrated in FIG. 8B alone, the subscriber goes to a POS reader that sells money or tokens. Such POS reader may be located conveniently in the merchant's premises.

The subscriber may give cash to the POS operator who may encode the amount, then taps his SIM card on the POS reader, as depicted by steps in blocks 2008, 2010 and 2012. Consequently, the subscriber's electronic wallet account is loaded with the amount he paid less any service fees.

Loading the POS reader with money or tokens may be done online. For as long as the POS reader has a balance of money or tokens, it may be arranged to dispense such balance in an online or offline mode.

The phone-to-phone loading, as particularly illustrated in FIG. 8C alone, may be done when both SIM cards are connected online to the subscribers' issuers.

For example, subscriber “A” may send money to subscriber “B” using the secured network of electronic devices and/or computers and then the amount which corresponds to the money may be sent to the issuer, as depicted by the flow of the arrows 2014, 2016. The issuer, using the same or another secured network, may send the same amount to subscriber “B.”

Conversely, subscriber “B” may also send money using the same or another secured network to subscriber “A” passing through the issuer. Likewise, the issuer sends the amount to subscriber “A” using the same or another secured network, as depicted by the flow of the arrows 2018, 2020.

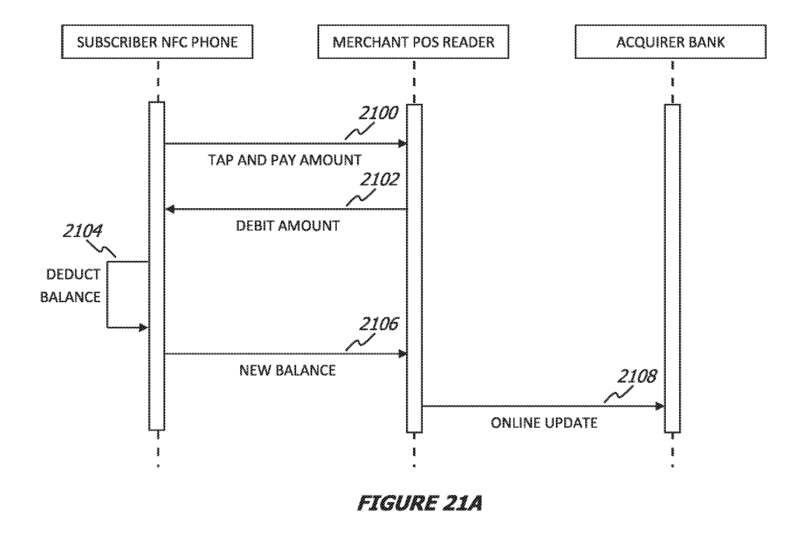

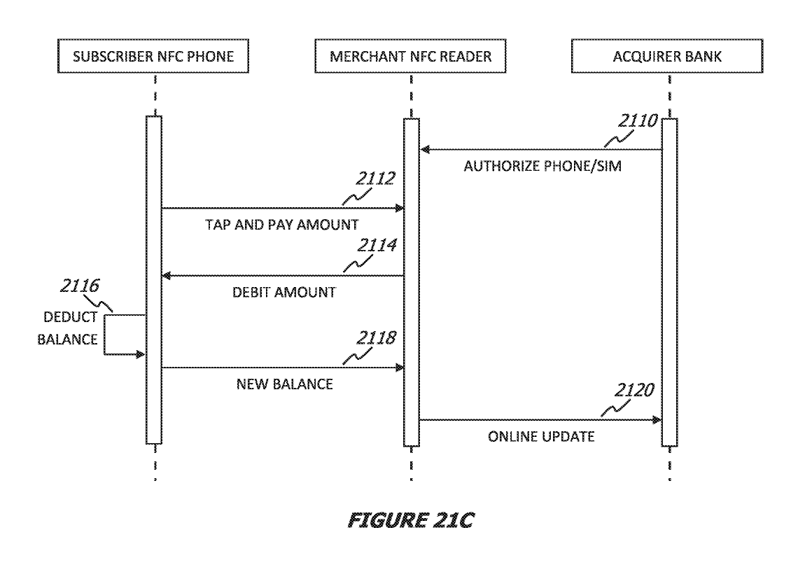

Referring now to FIGS. 21A and 21C, there are shown, respectively, a flow diagram illustrating a process for executing a payment transaction with an electronic wallet account associated with the integrated circuit device of FIG. 13 via phone to POS (point of sale) reader, and a flow diagram illustrating a process for executing a payment transaction with an electronic wallet account associated with the integrated circuit device of FIG. 13 via phone-to-phone.

In the process for paying with the e-wallet account via phone to POS reader as particularly illustrated in FIG. 9A alone, the subscriber may pay for goods and services he purchased from the merchant by tapping his SIM card on the POS reader conveniently located at the merchant's cashier station that may accept payments through credit, debit, and pre-paid cards, including NFC-enabled phones and SIM cards, as depicted by the flow of the arrow 2100.

By tapping the subscriber's SIM card on the POS reader, the amount due to the merchant may be deducted from his e-wallet account, as depicted by the flow of the arrow 2102. The acquirer may acquire all electronic transactions that go through the POS readers at the merchant's cashier and teller stations. The acquirer may subsequently instruct its payments processor to process the transactions for clearing and settlement, as depicted by the flow of the arrows 2104, 2106, 2108.

Payment through the digital passbook account may be done in an online or offline mode. Online means the e-wallet application can be used to pay the merchant while the POS reader is connected to any suitable back-end processing server. Offline means the e-wallet application can be used to pay the merchant even if the POS reader is not connected to the back-end processing server.

In the process for paying with the e-wallet via phone to POS reader as particularly illustrated in FIG. 98B alone, the acquirer who acquires all transactions from its designated POS readers can also acquire all transactions from NFC-enabled phones and SIM cards that act as NFC Reader.

The acquirer authorizes the phone or SIM card subscriber to use his phone or SIM card to accept banking and financial transactions involving money and tokens, as depicted by the flow of the arrow 2110. Hence, transactions can be performed or caused to be performed 24/7, anytime, anywhere, and on-demand.

As such, the SIM card subscriber may transfer money or tokens via SIM card to phone (assuming the phone may act as NFC Reader, or SIM card to SIM card (assuming the latter can also act as NFC Reader), as depicted by the flow of the arrows 2112, 2114, 2116, 2118, 2120.

Although not illustrated, a process for processing POS (i.e., via NFC phone) transactions will now be described. The payments processor will check the transactions of the acquirer by: (i) forwarding them to the SIM card issuer for verification; (ii) carrying out anti-fraud measures against the transaction; and (iii) checking previous payment history.

Once the payments processor receives verification from the issuer, it relays the information back to the acquirer who then completes the payment transaction. If the issuer denies the verification of the transaction, the payments processor relays the information to the acquirer, who then declines the transaction. Processing for the acquirer also includes monitoring, reporting and other services.

Although not illustrated, a process for clearing the banking and financial transactions will now be described. In banking and finance, clearing (usually done by third parties) denotes all activities from the time a commitment is made for a transaction until it is settled.

Clearing of payments is necessary to turn the promise of payment (for example, in the form of a check, electronic payment request, or stored value) into actual movement of money from one bank account to another or one bank to another bank.

During the clearing process, the acquirer provides the appropriate issuer with information on the sale or exchange of values. No money may be subject to exchange during clearing. Clearing involves the exchange of data only.

The acquirer provides data required to identify the subscriber's account with the issuer and to provide the dollar amount of the sales. When the issuer obtains these data, the issuer posts the amount of the sale as a draw against the subscriber's available credit or deposit and prepares to send payment to the acquirer.

Although not illustrated, a process for settling the banking and financial transactions is also described herein. Settlement involves the actual exchange of funds. The issuer sends a record of money or token being transferred from its account to that of the acquirer.

From this account, the acquirer pays the merchant for his goods and/or services purchased by the subscriber. The acquirer also distributes the merchant discount given by the merchant to the participants of the payment system.

One aspect of the present invention is directed to a computer system for implementing the distributed, ledger-based processing and recording of the electronic financial transaction. The system comprising: (i) the transaction device 200, 200a for initiating the financial transaction process associated with the financial transaction and in response to a first input signal received at the transaction device 200, 200a, for generating a transaction authorization message in response to a second input signal received at the transaction device 200, 200a, the transaction authorization message including identifiers of at least a source transaction account and a recipient transaction account which is distinct from the source transaction account, and debit and credit related data associated with the source and recipient transaction accounts, and for transmitting the transaction authorization message to the transaction processing system 300 with which the source transaction account is associated; and (ii) the transaction processing system 300 in operative communication with the transaction device 200, 200a and for processing and recording the transaction authorization message. The transaction processing system 300 is any one of a cluster of participating nodes associated with the source transaction account, a third party payment processing system associated with the cluster of participating nodes, and a distributed ledger system associated with the cluster of participating nodes. The debit and credit related data are automatically posted from the transaction authorization message to a device-resident ledger associated with a device-resident ledger system residing on the transaction device and, consequently, to any one of one or more node-resident ledgers associated with a node-resident ledger system residing on the cluster of participating nodes, one or more third party ledgers associated with a third party ledger system residing on the third party payment processing system, and one or more distributed ledgers associated with the distributed ledger system residing on a distributed network. The device-resident ledger system is a mirror of an issuer-resident ledger system maintained at the transaction processing system and corresponding to the node-resident ledger system.

Another aspect of the present invention is directed to a data processing device 200 for implementing a distributed, ledger-based processing and recording of an electronic financial transaction. The data processing device 200 comprising: (i) a data processor 222; (ii) a data memory system 206 in operative communication with the data processor 222; (iii) a data communications interface 210 coupled to the data processor 222; and (iv) a transaction application 224, 226, 228, stored on the data memory system 206 and which, when executed by the data processor 222 from data memory system 206, implements a method to, at least, initiate a financial transaction process associated with the financial transaction and in response to a first input signal received at the data processing device 200, generate a transaction authorization message in response to a second input signal received at the data processing device 200, the transaction authorization message including identifiers of at least a source transaction account and a recipient transaction account which is distinct from the source transaction account, and debit and credit related data associated with the source and recipient transaction accounts, and transmit the transaction authorization message to a transaction processing system 300 with which the source transaction account is associated. The transaction authorization message is processed and recorded by transaction processing system 300. The transaction processing system 300 is any one of a cluster of participating nodes associated with the source transaction account, a third party payment processing system associated with the cluster of participating nodes, and a distributed ledger system associated with the cluster of participating nodes. The debit and credit related data are automatically posted from the transaction authorization message to a device-resident ledger associated with a device-resident ledger system residing on the transaction device and, consequently, to any one of one or more node-resident ledgers associated with a node-resident ledger system residing on the cluster of participating nodes, one or more third party ledgers associated with a third party ledger system residing on the third party payment processing system, and one or more distributed ledgers associated with the distributed ledger system residing on a distributed network. The device-resident ledger system is a mirror of an issuer-resident ledger system maintained at the transaction processing system and corresponding to the node-resident ledger system.

Yet another aspect of the present invention is directed to an integrated circuit (IC) device 200a for implementing a distributed, ledger-based processing and recording of an electronic financial transaction, the IC device 200a comprising: (i) an IC processor 230a; (ii) an IC memory system 232a in operative communication with the IC processor 230a; (iii) an IC communications interface 244a coupled to the IC processor 230a; and (iv) a transaction application 256a stored on the IC memory system 232a and which, when executed by the IC processor 230a from the IC memory system 232a, implements a method to, at least, initiating a financial transaction process associated with the financial transaction and in response to a first input signal received at the IC device 200a, generating a transaction authorization message in response to a second input signal received at the IC device 200a, the transaction authorization message including identifiers of at least a source transaction account and a recipient transaction account which is distinct from the source transaction account, and debit and credit related data associated with the source and recipient transaction accounts, and transmit the transaction authorization message to a transaction processing system 300 with which the source transaction account is associated. The transaction authorization message is processed and recorded by transaction processing system 300. The transaction processing system 300 is any one of a cluster of participating nodes associated with the source transaction account, a third party payment processing system associated with the cluster of participating nodes, and a distributed ledger system associated with the cluster of participating nodes. The debit and credit related data are automatically posted from the transaction authorization message to a device-resident ledger associated with a device-resident ledger system residing on the transaction device and, consequently, to any one of one or more node-resident ledgers associated with a node-resident ledger system residing on the cluster of participating nodes, one or more third party ledgers associated with a third party ledger system residing on the third party payment processing system, and one or more distributed ledgers associated with the distributed ledger system residing on a distributed network. The device-resident ledger system is a mirror of an issuer-resident ledger system maintained at the transaction processing system and corresponding to the node-resident ledger system.

Yet another aspect of the present invention is directed to a computer program product which comprises a further non-transitory computer usable medium having a computer readable program code embodied therein, wherein the computer readable program code causes a computer or the computer system to implement a method to, at least: (i) initiative the financial transaction process associated with the financial transaction and in response to a first input signal received at the transaction device 200, 200a; (ii) generate the transaction authorization message in response to a second input signal received at the transaction device 200, 200a, the transaction authorization message including identifiers of at least a source transaction account and a recipient transaction account which is distinct from the source transaction account, and debit and credit related data associated with the source and recipient transaction accounts; and (iii) transmit the transaction authorization message to a transaction processing system 300 with which the source transaction account is associated, wherein the transaction authorization message is processed and recorded by the transaction processing system 300, wherein the transaction processing system 300 is any one of a cluster of participating nodes associated with the source transaction account, a third party payment processing system associated with the cluster of participating nodes, and a distributed ledger system associated with the cluster of participating nodes, wherein the debit and credit related data are automatically posted from the transaction authorization message to a device-resident ledger associated with a device-resident ledger system residing on the transaction device and, consequently, to any one of one or more node-resident ledgers associated with a node-resident ledger system residing on the cluster of participating nodes, one or more third party ledgers associated with a third party ledger system residing on the third party payment processing system, and one or more distributed ledgers associated with the distributed ledger system residing on a distributed network, and wherein the device-resident ledger system is a mirror of an issuer-resident ledger system maintained at the transaction processing system and corresponding to the node-resident ledger system.

A further aspect of the present invention is directed to a further computer system for implementing the electronic ledger-based processing and recording of an electronic financial transaction in the financial transaction. The system comprises the transaction device 200, 200a for initiating the financial transaction process associated with the financial transaction and in response to the first input signal received at the transaction device 200, 200a, for generating the transaction authorization message in response to the second input signal received at the transaction device 200, 200a, wherein the transaction authorization message includes identifiers of at least the source transaction account, the recipient transaction account distinct from the source transaction account, and the secure transaction token associated with the source transaction account and representing the monetary value, and for transmitting the transaction authorization message to the transaction processing system 300 with which the source transaction account is associated.

The further computer system also comprises the one or more distributed nodes 402 in operative communication with and public ledger system 400 and the transaction processing system 300 and located in the distributed network on which the distributed ledger system 400 resides, to which the transaction authorization message is forwarded from the transaction processing system 300, and for validating at least the association of the transaction token with the source transaction account based on one or more distributed ledgers within the distributed ledger system 400. The distributed ledger system 400 transfers the association of the transaction token from the source transaction account to the recipient transaction account based on the validation of the association of the transaction token with the source transaction account whereby the first transfer data is generated based on the transferred association of the transaction token, routes the first transfer data to the transaction processing system 300 which facilitates transfer of the monetary value from the source transaction account to the recipient transaction account based on the first transfer data whereby the second transfer data is generated based on the transferred monetary value. The transaction processing system 300 publishes the second transfer data on the distributed ledger system 400, and sends the second transfer data to the transaction device 200, 200a. In response to receipt of the second transfer data by the transaction device 200, 200a, the transaction device 200, 200a may cause the second transfer data to be recorded on and retrievable on demand from a device-resident ledger system which resides on the transaction device 200, 200a.

Yet another aspect of the present invention is directed to a further computer program product which comprises a further non-transitory computer usable medium having a computer readable program code embodied therein, wherein the computer readable program code causes a further computer or the further computer system to implement a method to, at least: (i) initiate the financial transaction process associated with the financial transaction and in response to the first input signal received at the transaction device 200, 200a; (ii) generate the transaction authorization message in response to the second input signal received at the transaction device 200, 200a, wherein the transaction authorization message includes identifiers of at least the source transaction account, the recipient transaction account distinct from the source transaction account, and the secure transaction token associated with the source transaction account and representing the monetary value; and (iii) transmit the transaction authorization message to the transaction processing system 300 with which the source transaction account is associated.

The method implemented by the computer or computer system as caused by the computer readable program code may also include communicating with the one or more distributed nodes 402. The one or more distributed nodes 402 may be located in the distributed network on which the distributed ledger system 400 resides, to which the transaction authorization message is forwarded from the transaction processing system 300, and for validating at least the association of the transaction token with the source transaction account based on one or more distributed ledgers within the distributed ledger system 400. The distributed ledger system 400 transfers the association of the transaction token from the source transaction account to the recipient transaction account based on the validation of the association of the transaction token with the source transaction account whereby the first transfer data is generated based on the transferred association of the transaction token, routes the first transfer data to the transaction processing system 300 which facilitates transfer of the monetary value from the source transaction account to the recipient transaction account based on the first transfer data whereby the second transfer data is generated based on the transferred monetary value. The transaction processing system 300 publishes the second transfer data on the distributed ledger system 400, and sends the second transfer data to the transaction device 200, 200a. In response to receipt of the second transfer data by the transaction device 200, 200a, the transaction device 200, 200a may cause the second transfer data to be recorded on and retrievable on demand from a device-resident ledger system which resides on the transaction device 200, 200a.

While the present invention has been described with respect to a limited number of implementations and/or embodiments, those skilled in the art, having benefit of this disclosure, will appreciate that other implementations and/or embodiments can be devised which do not depart from the scope of the present invention as disclosed herein.

1. A computer-implemented method of implementing a distributed, ledger-based processing and recoding of an electronic financial transaction, the method comprising the steps of:
initiating, by a transaction device, a financial transaction process associated with the financial transaction and in response to a first input signal received at the transaction device;
generating, by the transaction device, a transaction authorization message in response to a second input signal received at the transaction device, the transaction authorization message including identifiers of at least a source transaction account and a recipient transaction account which is distinct from the source transaction account, and debit and credit related data associated with the source and recipient transaction accounts;
transmitting, by the transaction device, the transaction authorization message to a transaction processing system with which the source transaction account is associated; and
processing and recording, by a transaction processing system, the transaction authorization message,
wherein the transaction processing system is any one of a cluster of participating nodes associated with the source transaction account, a third party payment processing system associated with the cluster of participating nodes, or a distributed ledger system associated with the cluster of participating nodes,
wherein the debit and credit related data are automatically posted from the transaction authorization message to a device-resident ledger associated with a device-resident ledger system residing on the transaction device and, consequently, to any one of one or more node-resident ledgers associated with a node-resident ledger system residing on the cluster of participating nodes, one or more third party ledgers associated with a third party ledger system residing on the third party payment processing system, and one or more distributed ledgers associated with the distributed ledger system residing on a distributed network, and
wherein the device-resident ledger system is a mirror of an issuer-resident ledger system maintained at the transaction processing system and corresponding to the node-resident ledger system.

2. The method according to claim 1, wherein the transaction device is implemented as an integrated circuit (IC) device.

3. The method according to claim 2, wherein the IC device comprises an IC processor, an IC memory system in operative communication with the IC processor, and an IC communications interface coupled to the IC processor.

4. The method according to claim 3, wherein the IC memory system embeds a transaction application which, when executed by the IC processor from the IC memory system, causes the processor to perform the steps of initiating, generating, and transmitting.

5. The method according to claim 4, wherein the step of transmitting utilizes the IC communications interface to transmit the transaction authorization message to the transaction processing system.

6. The method according to claim 3, wherein the IC device is in operative communication with a data processing device which comprises a data processor, a data memory system in operative communication with the data processor, and a data communications interface coupled to the data processor.

7. The method according to claim 6, wherein the IC memory system embeds a transaction application, which when executed by the data processor from the IC memory system, causes the data processor to perform the steps of initiating, generating, and transmitting.

8. The method according to claim 7, wherein the step of transmitting utilizes the data communications interface to transmit the transaction authorization message to the transaction processing system.

9. The method according to claim 1, wherein the transaction device is implemented as a data processing device which comprises a data processor, a data memory system in operative communication with the data processor, and a data communications interface coupled to the data processor.

10. The method according to claim 9, wherein the data memory system stores a transaction application which, when executed by the data processor from the data memory, cause the data processor to perform the steps of initiating, generating, and transmitting.

11. The method according to claim 10, wherein the step of transmitting utilizes the data communications interface to transmit the transaction authorization message to the one or more distributed nodes.

12. The method according to claim 1, wherein the device-resident ledger system is tracked by the distributed ledger system.

13. The method according to claim 1, wherein the node-resident ledger system is tracked by the distributed ledger system.

14. The method according to claim 1, wherein third party ledger system is tracked by the distributed ledger system.

15. The method according to claim 1, wherein the distributed ledger system is decentralized and based on blockchain technology.

16. A computer system for implementing a distributed, ledger-based processing and recording of an electronic financial transaction, the system comprising:
a transaction device for
initiating a financial transaction process associated with the financial transaction and in response to a first input signal received at the transaction device,
generating a transaction authorization message in response to a second input signal received at the transaction device, the transaction authorization message including identifiers of at least a source transaction account and a recipient transaction account which is distinct from the source transaction account, and debit and credit related data associated with the source and recipient transaction accounts,
transmitting the transaction authorization message to a transaction processing system with which the source transaction account is associated; and
a transaction processing system in operative communication with the transaction device and for processing and recording the transaction authorization message,
wherein the transaction processing system is any one of a cluster of participating nodes associated with the source transaction account, a third party payment processing system associated with the cluster of participating nodes, and a distributed ledger system associated with the cluster of participating nodes,
wherein the debit and credit related data are automatically posted from the transaction authorization message to a device-resident ledger associated with a device-resident ledger system residing on the transaction device and, consequently, to any one of one or more node-resident ledgers associated with a node-resident ledger system residing on the cluster of participating nodes, one or more third party ledgers associated with a third party ledger system residing on the third party payment processing system, and one or more distributed ledgers associated with the distributed ledger system residing on a distributed network, and
wherein the device-resident ledger system is a mirror of an issuer-resident ledger system maintained at the transaction processing system and corresponding to the node-resident ledger system.

17. A data processing device for implementing a distributed, ledger-based processing and recording of an electronic financial transaction, the data processing device comprising:
a data processor;
a data memory system in operative communication with the data processor;
a data communications interface coupled to the data processor; and
a transaction application stored on the data memory system and which, when executed by the data processor from data memory system, implements a method to, at least,
initiate a financial transaction process associated with the financial transaction and in response to a first input signal received at the data processing device,
generate a transaction authorization message in response to a second input signal received at the data processing device, the transaction authorization message including identifiers of at least a source transaction account and a recipient transaction account which is distinct from the source transaction account, and debit and credit related data associated with the source and recipient transaction accounts, and
transmit the transaction authorization message to a transaction processing system with which the source transaction account is associated,
wherein the transaction authorization message is processed and recorded by transaction processing system,
wherein the transaction processing system is any one of a cluster of participating nodes associated with the source transaction account, a third party payment processing system associated with the cluster of participating nodes, and a distributed ledger system associated with the cluster of participating nodes,
wherein the debit and credit related data are automatically posted from the transaction authorization message to a device-resident ledger associated with a device-resident ledger system residing on the transaction device and, consequently, to any one of one or more node-resident ledgers associated with a node-resident ledger system residing on the cluster of participating nodes, one or more third party ledgers associated with a third party ledger system residing on the third party payment processing system, and one or more distributed ledgers associated with the distributed ledger system residing on a distributed network, and
wherein the device-resident ledger system is a mirror of an issuer-resident ledger system maintained at the transaction processing system and corresponding to the node-resident ledger system.

18. An integrated circuit (IC) device for implementing a distributed, ledger-based processing and recording of an electronic financial transaction, the IC device comprising:
an IC processor;
an IC memory system in operative communication with the IC processor;
an IC communications interface coupled to the IC processor; and
a transaction application stored on the IC memory system and which, when executed by the IC processor from the IC memory system, implements a method to, at least,
initiate a financial transaction process associated with the financial transaction and in response to a first input signal received at the IC device,
generate a transaction authorization message in response to a second input signal received at the IC device, the transaction authorization message including identifiers of at least a source transaction account and a recipient transaction account which is distinct from the source transaction account, and debit and credit related data associated with the source and recipient transaction accounts, and
transmit the transaction authorization message to a transaction processing system with which the source transaction account is associated,
wherein the transaction authorization message is processed and recorded by transaction processing system,
wherein the transaction processing system is any one of a cluster of participating nodes associated with the source transaction account, a third party payment processing system associated with the cluster of participating nodes, and a distributed ledger system associated with the cluster of participating nodes,
wherein the debit and credit related data are automatically posted from the transaction authorization message to a device-resident ledger associated with a device-resident ledger system residing on the transaction device and, consequently, to any one of one or more node-resident ledgers associated with a node-resident ledger system residing on the cluster of participating nodes, one or more third party ledgers associated with a third party ledger system residing on the third party payment processing system, and one or more distributed ledgers associated with the distributed ledger system residing on a distributed network, and
wherein the device-resident ledger system is a mirror of an issuer-resident ledger system maintained at the transaction processing system and corresponding to the node-resident ledger system.
